(19) United States
(12) Patent Application Publication
(10) Pub. No.: US 2005/0060417 A1
(43) Pub. Date: Mar. 17, 2005

(54) Automated electronic personal preference & proxy network

(76) Inventor: Keith R. Rose, Danville, CA (US)

Correspondence Address: KEVIN J. CLARK, 6601 KOLL CENTER PARKWAY, SUITE 245, PLEASANTON, CA, 94566, US

(21) Appl. No.: 10/942,585

(22) Filed: Sep. 15, 2004

Related U.S. Application Data
(60) Provisional application No. 60/503,517, filed on Sep. 16, 2003.

(51) Int. Cl. G06F 15/16; G06F 15/173

(52) U.S. Cl. 709/228; 709/225

(57) ABSTRACT

An automated electronic personal preference & proxy network, that captures and exchanges personal profile information via an electronic means using network infrastructure is provided. Users may update preferences electronically. Permissions are generated in accordance with users permissions. Providers may enter an omnibus contract with an electronic agent, allowing various features such as cross-provider data transfer. An automated regulatory compliance engine is disclosed. An automated activity and offer engine is disclosed, to facilitate relevant offerings to users, and to automatically deepen user profiles. A violation engine for enforcing the contracts and regulations in an automated fashion is disclosed. Various other aspects are also disclosed.

### CLAIM OF PRIORITY UNDER 35 U.S.C. §119

This application Claims the benefit under 35 U.S.C. §119(e) of U.S. Provisional Patent Application Ser. No. 60/503,517, entitled “World-Wide Multi-Company Opt-In & Opt-Out Electronic Personal Profile Network” by Keith Rose, Filed Sep. 16, 2003.

### BACKGROUND

Background

Marketing messages are delivered from providers to users using a variety of channels. Examples include, telephone, web, e-mail, SMS, direct mail, instant message, cellular telephone, fax, and various others. Currently, users are inundated with solicitations from providers. Various regulatory structures have been or are being implemented to provide users with some control over the solicitations they receive. Various example regulations, such as the “do not call lists”, and others, are detailed further below. Given the immense quantity of marketing messages directed to users, users are becoming more and more likely to reject most or all solicitations, rather than wade through the morass of offers received. Many users would be happy to receive marketing messages from reputable companies for goods or services in which they are interested. Reputable providers would generally be pleased to avoid sending unwanted marketing messages to users who are not interested, thus targeting their marketing budget to those who may be genuinely interested. Once users gain control over the solicitations they receive, they may be more likely to be receptive to those offers. Thus, resolving the problem of unwanted solicitation is likely to benefit both providers and users.

It is currently possible, with substantial effort, for a user to contact a provider to indicate the user's preference about solicitations via one or more channels. Reputable companies generally provide opt-in and/or opt-out procedures for receiving marketing messages of any kind. However, disreputable providers may be apt to send additional unwanted messages once they receive a “live” response from a user, indicating the e-mail address, telephone number, fax number etc, as being received by a real person.

The regulatory environment continues to change, offering users protection from various types of communication (as well as potential confusion as to how to affect such protection), as detailed further below. However, given the vast number of providers, multiplied by the differing regulatory regimes for each channel type, a user attempting to tailor their marketing receptiveness faces a daunting task. There is therefore a need in the art for an automated electronic personal preference and proxy network.

### BRIEF DESCRIPTION OF THE DRAWINGS

FIG. 1 depicts an example embodiment of an electronic personal preference network;

FIG. 2 depicts an example embodiment of electronic personal preference network deployed in a distributed system;

FIG. 3 depicts an example embodiment of an electronic agent;

FIG. 4 is an example block diagram of an electronic agent;

FIG. 5 depicts an example embodiment of a method for proxy contract formation between a user and an electronic agent;

FIG. 6 illustrates an example embodiment of method for forming an omnibus contract between one or more providers and an electronic agent;

FIG. 7 depicts an example embodiment of method for updating preferences, profiles, and permissions in response to user changes;

FIG. 8 depicts an example embodiment of a provider;

FIG. 9 is an example embodiment of a portion of an electronic personal preference network illustrating intra-provider or cross-provider communication;

FIG. 10 illustrates an example method for enabling cross-provider communication;

FIG. 11 depicts an example embodiment of an enforcement engine;

FIG. 12 depicts an example embodiment of method for enforcement;

FIG. 13 illustrates various means for generating and transmitting requests to providers;

FIG. 14 illustrates an example embodiment of a method for preemptively enforcing permissions according to each users preferences;

FIG. 15 illustrates an example embodiment of a method for automating the complaint/violation enforcement process;

FIG. 16 illustrates an example embodiment of an enforcement engine interfacing with a legal or regulatory agency;

FIG. 17 depicts an example embodiment of a compliance clearinghouse;

FIG. 18 depicts an example embodiment of a method for performing a compliance clearinghouse function;

FIG. 19 depicts an example embodiment of an activity & offer engine;

FIG. 20 illustrates an example embodiment of a method illustrating various activity & offer engine activities;

FIG. 21 depicts an example embodiment of method for automated permission updating;

FIG. 22 depicts an example embodiment of a method for automated selection and notice of potential relevant services;

FIG. 23 depicts an example embodiment of a method for automated database crawling;

FIG. 24 illustrates an example embodiment of a method for automated contract creation based on preferences, permission and proxy;

FIG. 25 is an example embodiment of an electronic agent, illustrating using position location in accordance with profiles and permissions to generate time and location specific delivery of services and/or offers;

FIG. 26 depicts an example embodiment of an automated personalized spam filter;

FIG. 27 depicts an example embodiment of a method for automated personalized spam filtering;

FIG. 28 depicts an example embodiment of a method for enhancing searching, based on preferences permissions and profiles;

FIG. 29 is an example embodiment of a method for monitoring aggregated user preference trends;

FIG. 30 depicts an example embodiment of a user interface for entering a user proxy agreement; and

FIG. 31 is an example embodiment of a user interface illustrating preference control, offers, and example statistics.

### DETAILED DESCRIPTION

One or more exemplary embodiments described herein are set forth in the context of a network system. While use within this context is advantageous, different embodiments of the invention may be incorporated in different environments or configurations. In general, the various systems described herein may be formed using software-controlled processors, integrated circuits, or discrete logic. The data, instructions, commands, information, signals, symbols, and chips that may be referenced throughout the application are advantageously represented by voltages, currents, electromagnetic waves, magnetic fields or particles, optical fields or particles, or a combination thereof. In addition, the blocks shown in each block diagram may represent hardware or method steps. Method steps can be interchanged without departing from the scope of the present invention. The word “exemplary” is used herein to mean “serving as an example, instance, or illustration.” Any embodiment described herein as “exemplary” is not necessarily to be construed as preferred or advantageous over other embodiments.

A unique way to create an electronic personal profile transaction engine, i.e. electronic agent 30, that captures and exchanges personal profile information via an electronic means using the Internet, or similar electronic network infrastructure is provided. The personal profile transaction engine may work across an array of participating companies and can work across various industries. Transaction data may be converted to information that is shared between participating companies. Participating companies may place a monetary value on the data and may track the exchange of information to identify their net economic/monetary balance due to the coalition of participating companies.

Electronic personal preferences and profiles may be solicited, developed and changed via electronic input from an array of participating cooperative companies based upon direct input from participating individuals or businesses that give permission either directly, or through proxy to take action. Individuals may change, adjust & personalize their preferences over time.

Electronic agents may be given authority to act on behalf of participating individuals or businesses via an electronic proxy to automate the process of developing or changing participant's information and preference settings. Electronic agents may use the preference and information to drive automated actions that are designed to benefit participating individuals, such as requesting removal from marketing lists of undesirable companies, and providing electronic permission for desirable companies to work together to enhance service to the participating individual or business.

Electronic tracking may be used to identify if companies are complying with requests, if companies fail to comply an innovative new e-driven cascade-request engine will be used to motivate compliance. This cascade-request engine may use an increasing level of frequency of requests. The tracking will also be used to support and automate a new e-driven legal engine that automates the process of class action and/or other legal action against companies that fail to comply with specific requests and regulations.

A unique Electronic Clearinghouse may be used to automate the process of how companies can confirm and demonstrate regulatory compliance for participating individual's specific preferences and permissions.

A network, such as the Internet, may be used to acquire profile information that drives proactive requests to companies, in an automated fashion, to stop sending material or to start sending offers. The Internet profile may drive data base profiles that in turn will drive proactive requests to companies that are in a company contact database. The company contact database may be comprised of key contact information such as e-mail, phone, and direct mail. This database may be used to drive in an automated process requests to start sending, stop sending, or change material and offers provided to participants. If companies do not comply with the requests, there may be triggers to drive more aggressive requests and force the appropriate behavior.

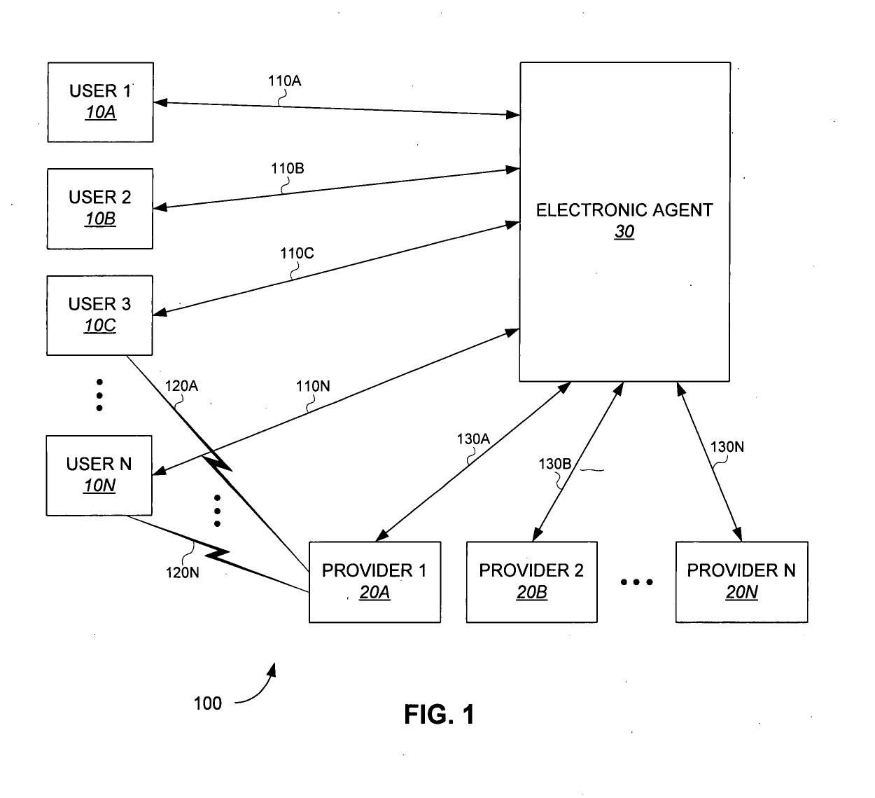

FIG. 1 depicts an example embodiment of an electronic personal preference network 100. Users 10 are shown in communication with providers 20 over various communication channels 120. Providers 20 (i.e. providers 1-N, 20A-20N, respectively) represent any individual business(or division thereof), or other organization which may wish to communicate from time to time with one or more users (i.e. users 1-N, 10A-10N, respectively). A commercial provider 20 typically has goods and/or services to sell and wishes to solicit one or more users to purchase those goods or services. Note that a provider 20, in general, is any participant wanting to communicate with a user (reputable providers will do so in accordance with preferences and/or laws). A provider 20 need not be a commercial enterprise, or offer any good or service (i.e. survey requesters, non-profit organizations, any organization with a message to convey, etc.).

Examples of communication channels 120 include, telephone, web, e-mail, SMS, direct mail, instant message, cellular telephone, fax, and various others. An example web interface may present offers to a user visiting that provider's website (or an affiliated website), or may present an offer or advertisement when a user conducts a search (i.e. using a search engine). Currently, users are typically inundated with solicitations from providers. Various regulatory structures have been or are being implemented to provide users with some control over the solicitations they receive. Various example regulations, such as the “do not call lists”, and others, are detailed further below. Given the immense quantity of marketing messages directed to users, users are becoming more and more likely to reject most or all solicitations, rather than wade through the morass of offers received. Many users would be happy to receive marketing messages from reputable companies for goods or services in which they are interested. Reputable providers would generally be pleased to avoid sending unwanted marketing messages to users who are not interested, thus targeting their marketing budget to those who may be genuinely interested. Once users gain control over the solicitations they receive, they may be more likely to be receptive to those offers. Thus, resolving the problem of unwanted solicitation via the various channels 120 is likely to benefit both providers and users. Those likely to be negatively affected generally include disreputable providers who are insensitive to their target audience. It is currently possible, with substantial effort, for a user 10 to contact a provider 20 to indicate the user's preference about solicitations via one or more channels. Reputable companies generally provide opt-in and/or opt-out procedures for receiving marketing messages of any kind. However, disreputable providers may be apt to send additional unwanted messages once they receive a “live” response from a user, indicating the e-mail address, telephone number, fax number etc, as being received by a real person. The regulatory environment continues to change, offering users protection from various types of communication (as well as potential confusion as to how to affect such protection), as detailed further below. However, given the vast number of providers, multiplied by the differing regulatory regimes for each channel type, a user attempting to tailor their marketing receptiveness faces a daunting task.

Electronic agent 30 may be deployed to automate the process of tailoring a user's desired communication with providers attempting to reach them. Users 10 may communicate with electronic agent 30, as shown with connections 110A-N, and providers 20 may communicate with electronic agent, as shown, with connections 130A-N.

As detailed further below, an electronic personal preference network 100, enabled by electronic agent 30, may effectively manage the information flow between providers, both compliant and non-compliant, and users, by forming a number of legal constructs. An omnibus contract with each user (i.e. customers) may be formed between electronic agent 30 and each user 10. The omnibus contract incorporates a set of preferences for the respective user. Various techniques for automating the process of selecting preferences for users are detailed further below. Thus, an opt-in network is formed, with the electronic agent 30 acting as legal agent on behalf of customers to initiate, stop, or adjust contact from providers 20 according to the best interest of the user (as well as the provider).

A single omnibus contract may be used for each user to establish the electronic agent as a proxy for all the activities within the boundaries selected by the user. Users may modify, strengthen or cancel their preferences at any time. The electronic agent 30, in accordance with the preferences and its proxy authority, may establish permissions for one or more providers to communicate with the user over one or more channels 20. A user may set the preferences to any desired level, including stopping all marketing messages of any kind on any channel. Electronic agent 30 may preemptively issue cease and desist messages to providers, in accordance with available regulatory regimes, and with user preferences. The electronic agent may also undertake enforcement action subsequent to discovery of a communication violation by a provider.

Providers may opt-in to participate in a coalition of providers 20. These providers may also be referred to herein as coalition members or preferred providers. Coalition members may enter into an omnibus contract with each other and with electronic agent 30. All participating providers agree to act according to a common set of rules and roles, as specified in the omnibus contract. One feature of the omnibus contract is that coalition companies agree not to violate the preferences and the associated permissions granted in accordance with a users preference. Coalition members, when permitted by the user, may agree to package and share information about a user according to guidelines incorporated in the omnibus contract, as well as complying with applicable regulations.

Electronic agent 30 may provide automated regulatory compliance services so that providers may communicate with users, confident that they are acting within local regulations according to the jurisdiction applicable to that communication. Thus, electronic personal preference network 100 incorporates an electronic personal profile transaction engine (i.e. electronic agent 30) to capture and exchange personal profile information via an electronic means, to the Internet, or other electronic network infrastructure. The network, i.e. the Internet, facilitates a novel process for creating a streamlined omnibus agreement, system & organizational structure to share personal profile information across companies (i.e. providers) that would normally have privacy conflicts and/or no data connection. Electronic personal profiles may be solicited, developed and changed via electronic input from an array of participating cooperative companies based upon direct input from participating individuals or businesses that give permission either directly, or thru proxy to take action. Users, either individuals or other organizations, may change, adjust and personalize their preferences over time.

Electronic agent 30 may act on behalf of individual participants or businesses to seek out offers, using information via the Internet, to automate the process of an individual finding and selecting goods & services for purchase. This is an example of an ongoing active, or proactive, search, in which the electronic agent continues to monitor and develop potential offerings and information in accordance with user specified preferences, and other parameters.

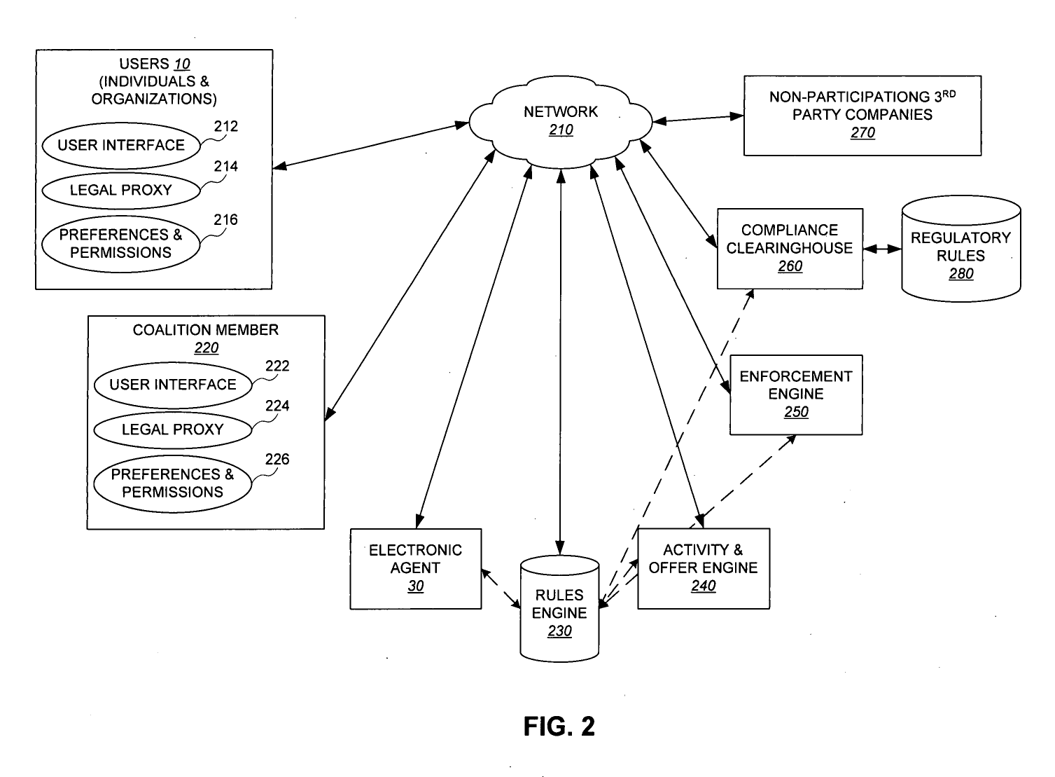

FIG. 2 depicts an example embodiment of electronic personal preference network 100 using a network deployed in a distributed system. Electronic personal profile network 100 may use, for example, a client/server architecture. The various components depicted in FIG. 2 are interconnected via network 210. In the example embodiment network 210 may include corporate intranets, proprietary networks, wired or wireless networks, as well as the Internet. In this example, users 10 and providers 20 interface with electronic agent 30 over network 210.

Providers that have joined the provider coalition network, such as that described above, are identified as coalition members 220. To distinguish from coalition members 220, non-participating third parties companies 270 are shown. Non-participating third party organizations 270 may include providers who are likely to comply with applicable regulations as well as providers who do not comply.

In addition to electronic agent 30, compliance clearinghouse 260, enforcement engine 250, and activity & offer engine 240 are interconnected via network 210 as well. These functions are shown as separate entities, in this example, for clarity of discussion. In an alternate embodiment, one or more of these functions may be incorporated within electronic agent 30. Rules engine 230 is also interconnected with network 210. As indicated by dashed lines, alternate direct connections to rules engine 230 may be formed. In this example, electronic agent 30, activity & offer engine 240, enforcement engine 250, and compliance clearinghouse 260 may directly connect with rules engine 230.

Users 10 may include both individuals and organizations such as businesses, nonprofit organizations, and any other group. Users interface according to user interface 212 connected to network 210. In an example embodiment, the user interface may include any type of software client, such as a web browser or proprietary client. A user 10 may interface with the various components depicted in FIG. 2 via user interfaces on a personal computer, cellular telephone, personal data assistant (PDA), automated telephone interface, e-mail, or any other type of communication interface. In an alternate embodiment, written submission such as fax and/or direct mail may be used, in including scantron surveys, or with Optical Character Recognition (OCR) as well.

For each user, having entered into an omnibus contract described above, legal proxy 214 is formed giving proxy authorization to electronic agent 30 to perform various functions detailed herein, in accordance with user defined preferences. Electronic agent 30 generates permissions associated with providers of various types and for various communication channels. A user's preferences and permissions 216 may be amended at any time using electronic agent 30. A user may set preferences and permissions at any time via network 210. Various example procedures, detailed below, may be manual, automated, or a combination of the two (for example, presentation of preferences or permissions, and user acceptance of the same).

Preferences may include various information. For example, identification information such as a user's name, social security number, driver's license, unique identifier, account number, address, e-mail, telephone numbers, instant message identification, and any other contact information may be stored. Identification information may include more than one personality for each user such as preferences for work set differently than preferences set at home, and may accompany sets of contact information for various personalities. There may also be a process for creating a personal identifier and password to facilitate a secured log in by users. This security feature is common to what is currently deployed for online purchases and online account access. Preferences may include turning on and off communication on channel types, (i.e. phone, direct mail e-mail etc.). Preferences may be initiated by the user, selected as one of a set of predetermined profiles. A predetermined profile may provide more or less flexibility for providers to send solicitations, and may be tailored for certain industry types (such as financial services, healthcare, various retail sectors, and the like). Preferences may be set and/or modified using simplified graphical interfaces, such as sliders, corresponding to permission levels for various industry types or privacy requirements, examples of which are detailed below. A user may manually enter preferences at any level of detail. The user interface may provide the opportunity for the user to view preferences in detail as well as edit them. As just described, a user may receive proposed preference changes, perhaps with respect to activity & offer engine 240, and may choose to accept or deny.

A unique profile identifier key may be provided. Electronic agent 30 may provide an automated process for creating the unique identifier that may be used across coalition members to provide a common Identifier that works across various companies and may replace the social security number, or other account numbers, with a more secure way to identify an individual or business. This may allow companies to link account information but not share account numbers.

Similarly, coalition members 220 may interface with one or more components in the electronic personal preference network 100 via user interface 222. A secured login process may be in place to protect access. A legal proxy 224 may be made, authorizing electronic agent to act as proxy in place of one or more coalition members, or the coalition as a whole. Preferences and permissions 226 may be updated via network 210 as well.

Compliance clearinghouse 260 is shown connected to regulatory rules database 280. Compliance clearinghouse 260 may be used to determine whether or not providers have complied with user preferences, applicable regulatory regimes, common rules and roles of coalition members (according to their omnibus contract) and any coalition member preferences that may be specified. Example regulatory requirements include Federal Regulations, State Regulations, Corporate Policies, International Regulations, and Association Regulations (for example: the Direct Marketing Associations Rules of Conduct for Members). Example legislation is detailed below in Table 1.

Enforcement engine 250 may be used to provide varying levels of response to communications or solicitations from a provider, whether a coalition member 220, or a nonparticipating party company 270. Various responses may be elevated in response to noncompliance. Various enforcement techniques are detailed further below. A coalition member may update preferences and permissions in like fashion to that described for users, but may also indicate provider-specific information such as types of offers, additional restrictions on privacy and/or permission, cross communication with other coalition members (detailed further below), as well as various contact information and the like.

Activity & offer engine 240 provides various functions designed to automatically deepen permissions, automatically deepen preference profiles, and identify and/or generate offers accordingly, details of which are detailed further below. This may be a separate function from the electronic agent 30. The activity & offer engine 240 provides the functionality of tracking activities, offers and responses and generating new profile data, and automating updates accordingly to make the profile and preferences more relevant.

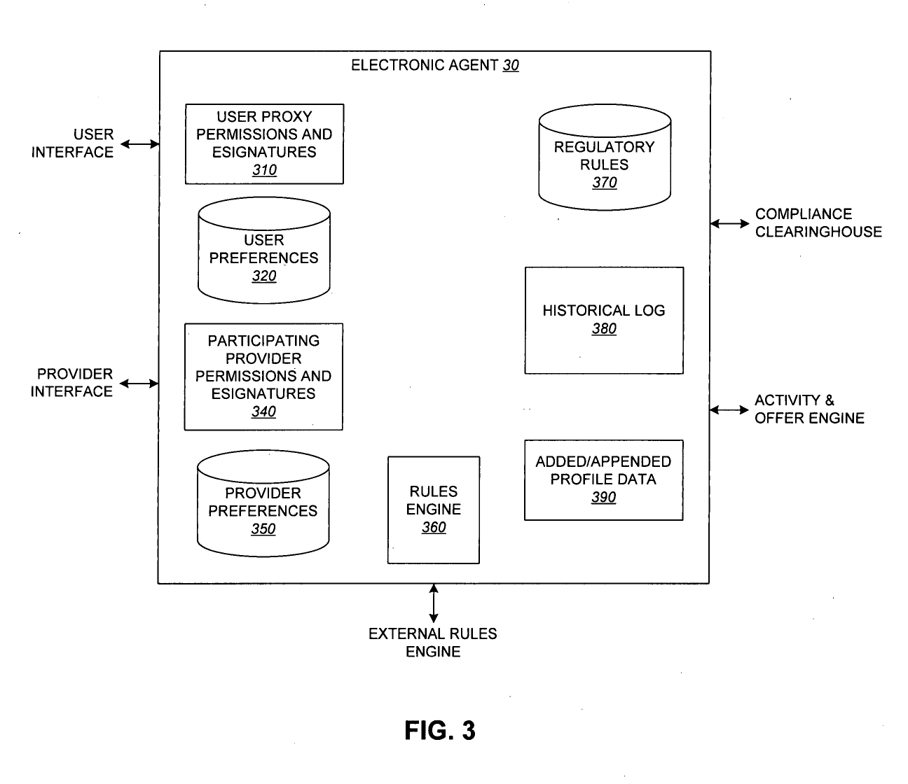

FIG. 3 depicts an example embodiment of an electronic agent 30. An electronic agent 30 may be hosted at one site, using one or more servers, and any web architecture, may be distributed, may be private labeled for multiple companies (and hosted at one or more server sites).

User proxy permissions and electronic signatures are stored as shown in block 310. This information may be updated via connection to the user interface, described above. User preferences are stored in user preferences database 320. In similar fashion, a provider interface, such as that described above, is used to generate provider permissions, which are stored along with electronic signatures as shown in block 340. Provider preferences are stored in provider preferences database 350. Provider preferences, in addition to contact information, etc., may include preferences on other participating providers with whom to cooperate, restrictions on parameters of various offer types, such as time periods, geographical locations to target, user demographics, etc. In addition, a given provider may have privacy and/or communication policies that are more restrictive than those dictated by the applicable regulatory environment.

Regulatory rules database 370 contains regulations applicable to the various types of supported channels. Note that, in an alternate embodiment, a connection to regulatory rules database 280 may be substituted. Historical log 380 is maintained to record changes in user and/or provide preferences, contacts with users and/or third parties, updates from participating companies, other historical indicators imported from participating companies, other preference codes reflecting historical activity, and any other data desired to be logged. Note that historical log 380 may be made available to compliance clearinghouse 260 for determining compliance, or to activity & offer engine 240, detailed further below.

Added/appended profile data 390 includes various information used to deepen user profiles. For example, information regarding previous transactions may be stored, as well as correlations between various previous transactions. For example, a user may have demonstrated a preference for a certain type of item or service purchased in conjunction with certain time periods or in conjunction with other purchases. This type of information may be used to deepen the profile, and may be used in determining whether a user is a match for a particular marketing proposal. For example, a participating provider may want to target users (whose preferences provide permission) and who have purchased a certain good or service within the last year.

Rules engine 360 uses the information stored in the various components to carry out various tasks, examples of which are detailed below. Note that, in an alternate embodiment a connection to an externally located rules engine 230 may be deployed in conjunction with or in place of rules engine 360. Examples of various procedures that may be carried out by electronic agent 30, utilizing rules engine 360, in conjunction with the various components just described, are detailed further below.

The electronic agent depicted in FIG. 3 illustrates logic that drives activity across components in the figure. For example, given proxy permissions from an individual and certain permissions from a provider (historical log 380 indicates whether something has changed), then rules engine 360 would indicate activities to perform in response to a change, such as: push out emails, update data, etc. The rules engine may comprise a processor and software in contact a database containing various rules. Rules engines are known in the art, and provide a mechanism to automate tasks.

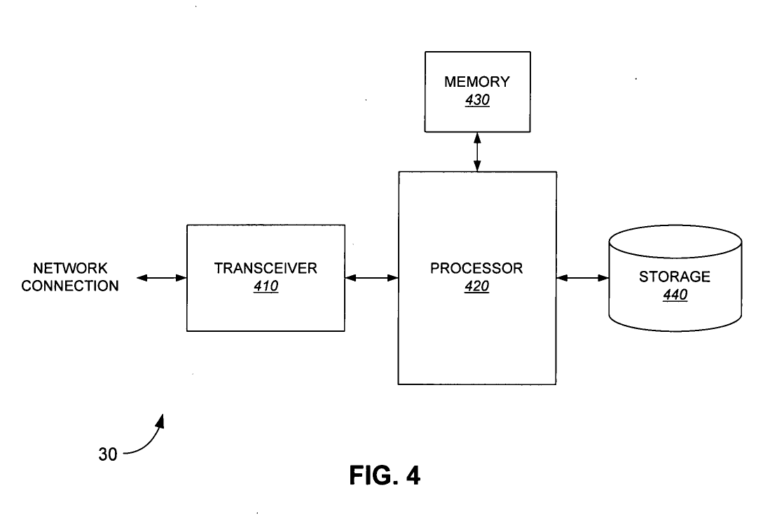

FIG. 4. depicts an example schematic embodiment of an electronic agent 30. This example is suitable for deployment as electronic agent 30 depicted in FIG. 2. Network 210 is connected to transceiver 410, which transmits and receives according to the applicable communication format of network 210. An example embodiment is compatible with transmission according to the Internet Protocol (IP). Transceiver 410 delivers received data from network 210 to processor 420, and transmits messages and/or data from processor 220 to one or more locations connected to network 210 via transceiver 410. Processor 220 may be a general-purpose microprocessor, a digital signal processor (DSP), or a special purpose processor. Processor 420 may be connected with special purpose hardware to assist in various tasks (details not shown). Various applications may be run on externally connected processors such as on an externally connected server, or a server connected over a network connection. Applications may run on an additional processor within electronic agent 30 (not shown), or may run on processor 420, itself. Processor 420 is shown connected with memory 430, which may be used for storing data as well as instructions (i.e. software or firmware) for performing the various methods and procedures described herein. Those of skill in the art will recognized that memory 430 may be comprised of one or more memory components, of various types, that may be embedded in whole or in part of within processor 420. Storage element 440 may also connected to processor 420, and used for deploying one or more of the various databases described herein. Storage element 440 may comprise a hard disk drive, taped drive or any equivalent. Storage 440 may incorporate a plurality of such media as well. Those of skill in the art will recognize various components described herein may be performed using software techniques, examples are given above and detailed further below. Such software may be stored in instructions in memory 430 and/or storage 440 for execution on processor 420. Software modules may interoperate with databases, such as those described above, which may be remotely located and accessed via network connection 210, or via direct connection (as shown in FIG. 2).

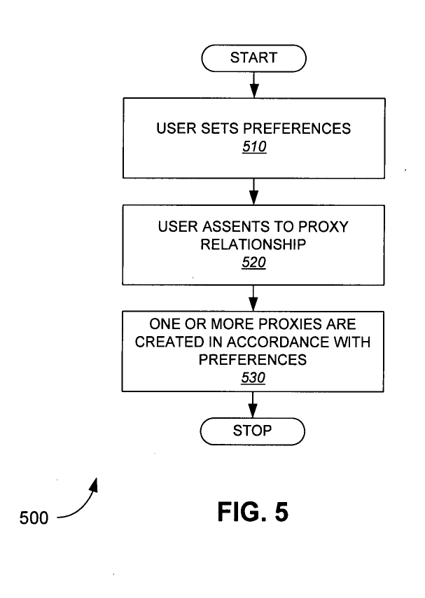

FIG. 5 depicts an example embodiment of a method 500 for proxy contract formation between a user and an electronic agent. At 510, the user sets preferences according to any of the techniques detailed herein. A user may select from a predefined set, when initiating a set of preferences and/or may explicitly set preferences in as much detail as the user desires. Various other controls for tailoring enhancements of privacy and/or allowing increased communication from one or more providers may be deployed. Additional techniques for setting customer preferences are detailed further below.

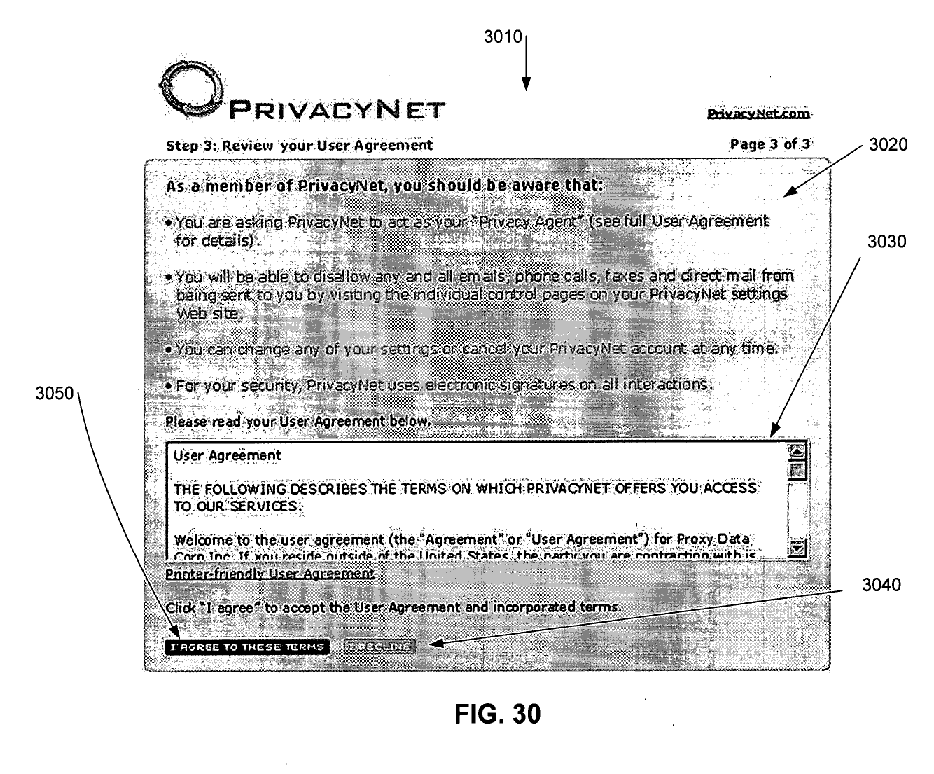

At 520, the user assents to a proxy relationship with the electronic agent. This forms a contract between the electronic agent and the user, and allows the electronic agent to act on behalf of the user in accordance with the user's set preferences. The contract incorporates the user's preferences as well as the user's right to modify the preferences at any time in the future, including canceling the proxy relationship and/or increasing or decreasing any amount of solicitation and/or sharing of personal data that the user desires. The electronic agent presents the terms of the contract for the users review, an example of which is depicted below with respect to FIG. 30.

At 530, one or more proxies are created for the user in accordance with the set preferences and in compliance with various regulatory requirements. The validity of an electronic assent, such as an electronic signature (esignature), may vary in accordance with the governing jurisdiction, typically geographically bounded, as well as according to regulations directed to specific types of communication. Example regulations are detailed further below in Table 1. Electronic agent 30, in accordance with regulatory rules 370 may ensure that the user is in compliance with applicable regulations. Proxy permissions and esignatures may be stored as depicted in block 310 above. User preferences may be stored in user preferences database 320, as illustrated above.

Thus, individual participants or businesses (or other organizations) may use an electronic interface to provide innovative proxy-oriented permission and preferences via an electronic means for a personal profile electronic agent to act on their behalf and automate the process of eliminating undesired marketing materials (email, web, paper, fax, advertising, etc.) and/or automate the process of providing permission for specific companies to use their data for the benefit of other participants. Participating companies may use the data individually or collaboratively by sharing information via an electronic transaction engine, as detailed below. Individual participants or businesses (or other organizations) agree to provide a legal proxy that may be used in an electronic environment to automate world-wide opt-in and opt-out via the electronic personal preference network 100.

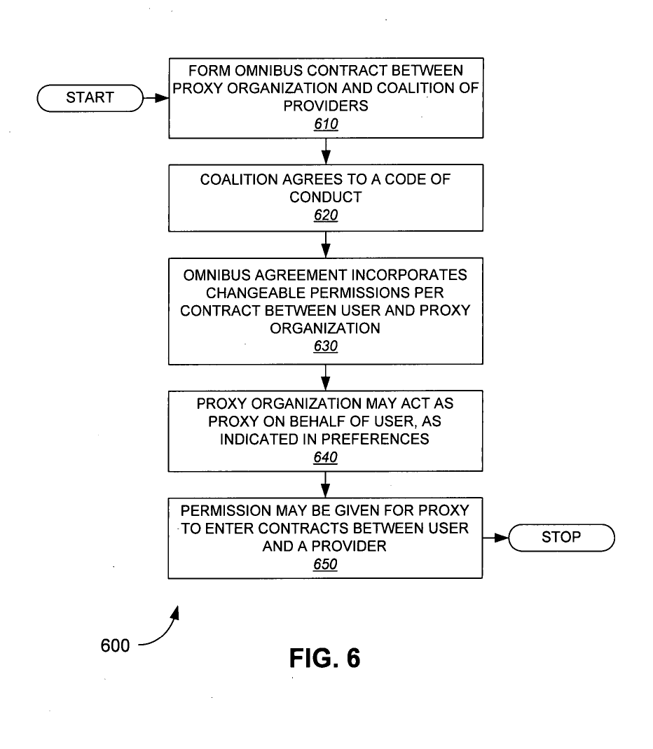

FIG. 6 illustrates an example embodiment of method 600 for forming an omnibus contract between one or more providers and an electronic agent. At 610, the omnibus contract is formed between the proxy organization (i.e. electronic agent 30) and a coalition of one or more providers, such as coalition members 220, as detailed above. Each provider may specify provider preferences for storing a provider preferences database 350, illustrated above. Each provider also assents to formation of the contract, which will be presented to that provider, and in a proper electronic signature or other assent (that complies with applicable regulations) will be stored to memorialize each party's assent to the omnibus contract, as shown.

At 620, each coalition member agrees to a code of conduct to apply to the coalition. At 630, the omnibus agreement incorporates changeable permissions, through the contract between each user and the proxy organization. A permission given to a coalition member allows that member to communicate according to the parameters of the permission. For example, a permission may authorize a particular provider to communicate with a user via telephone. A permission may specify more details, such as a time of day during which telephone calls are prohibited or explicitly allowed. Any level of detail in permissions may be supported. Permissions for a single provider may vary according to channel. For example, a user may allow weekly email offers, or may restrict email communication to one weekly email offer, but may explicitly allow a telephone call permission when certain other criteria have been met. For example, a user wishing to refinance a real estate mortgage may specify a target interest rate, below which an approved provider may directly contact that user. Those of skill in the art will recognize myriad combinations of permissions according to user preferences and channel types.

At 640, the proxy organization may act as proxy on behalf of a user as indicated in the user's preferences, detailed above. Thus, the proxy organization, or electronic agent, may award and rescind permission, may solicit proposals of different types from various providers, and may enable the sharing of various user data between selected coalition members, as detailed further below.

At 650, permission may optionally be given for the proxy (i.e. electronic agent) to enter contracts between the user and a provider. Such a contract may allow the proxy to search for a good or service according to predefined parameters and bind the parties automatically once a suitable match is found. Note that, if such contract is supported by a given embodiment, the user may disable that feature, if so desired.

Thus, coalition participants agree to an omnibus contract that creates a common platform for sharing information electronically in ways that are consistent with individual participant or business desires. An electronic method of creating, controlling, and changing the ability for multiple companies to work cooperatively to benefit an end-user by sharing the end-user's personal data is provided. This may include an electronic means of capturing and updating an omnibus agreement that would function across participating companies or organizations.

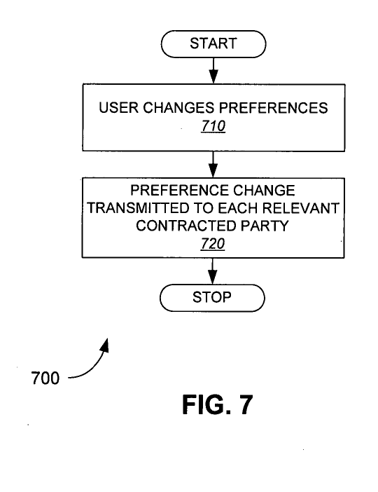

FIG. 7 depicts an example embodiment of method 700 for updating preferences, profiles, and permissions in response to user changes. At 710, a user changes preferences, using any of the techniques detailed above. For example, a user may explicitly change preferences to allow a new type of offer to be made to that user. Or, a user may disallow use of a certain channel by one or more providers, etc.

At 720, once a preference change has been made by the user, that change is transmitted to each relevant contracted party. For example, if a preference is changed to be more restrictive, one or more permissions may need to be amended and/or withdrawn that have been previously issued to one or more providers. If a less restrictive change is made, new permissions may be generated and transmitted to one or more providers, in accordance with other specified permissions.

Coalition companies may share an electronic backbone that acts as a conduit for information to flow or be stopped according to the preference profile of individual participants. Individual participants, businesses, or other organizations may provide a simple and brief set of profile information including name, address, social security number, family/employee members, and marketing preferences, which may be amended automatically or explicitly over time.

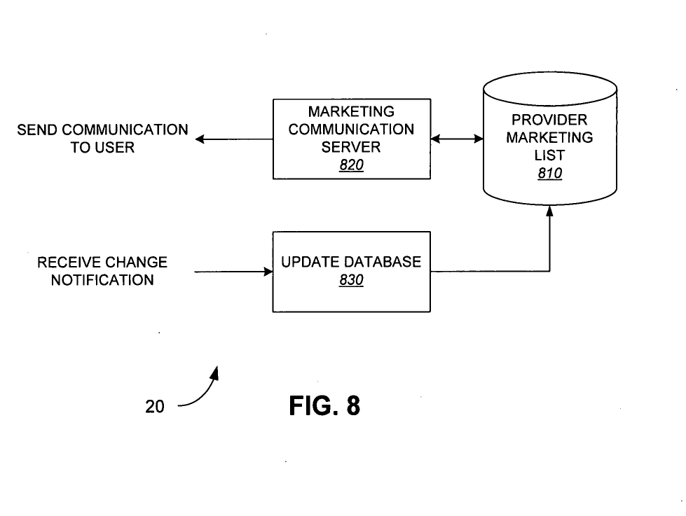

FIG. 8 depicts an example embodiment of a provider 20. In this example, provider 20 includes provider marketing list 810, which contains a list comprised of contact information for one or more users, along with any other demographic data that may be stored along with that user (such as transaction history, and the like). Marketing communication server 820 may generate marketing communication messages to one or more users from the provider marketing list 810, and may send communications to users accordingly. Note that a provider 20 may or may not be a coalition member, and may or may not comply with regulations when transmitting a communication.

Database update 830 may receive change notifications from electronic agent 30. If the provider is a coalition member, then, in accordance with the omnibus provider contract, provider 20 should update provider marketing list 810 accordingly. If a provider 20 is not a coalition member, but desires to comply with user requests and other regulatory requirements, that provider 20 may receive notification from electronic agent 30 and update its provider marketing list accordingly. In either case, communication to that user will either begin, cease, or change according to the received change notification.

A non-complying provider may receive a change notification, or other message from electronic agent 30, and decide not to comply. Such a non-compliance is generally referred to herein as a violation, and techniques for processing violations are detailed further below.

In the context of the discussion of FIG. 7, provider 20 receives change notification subsequent to a user change in preferences, and updates the provider marketing list accordingly in order to remain in compliance with regulations as well as the provider omnibus contract. Thus, electronic agent 30 automates the process of providing opt-in and opt-out information to companies at their source-marketing database. This facilitates the halt of undesired communication at its source, rather than just filtering (i.e. email spam).

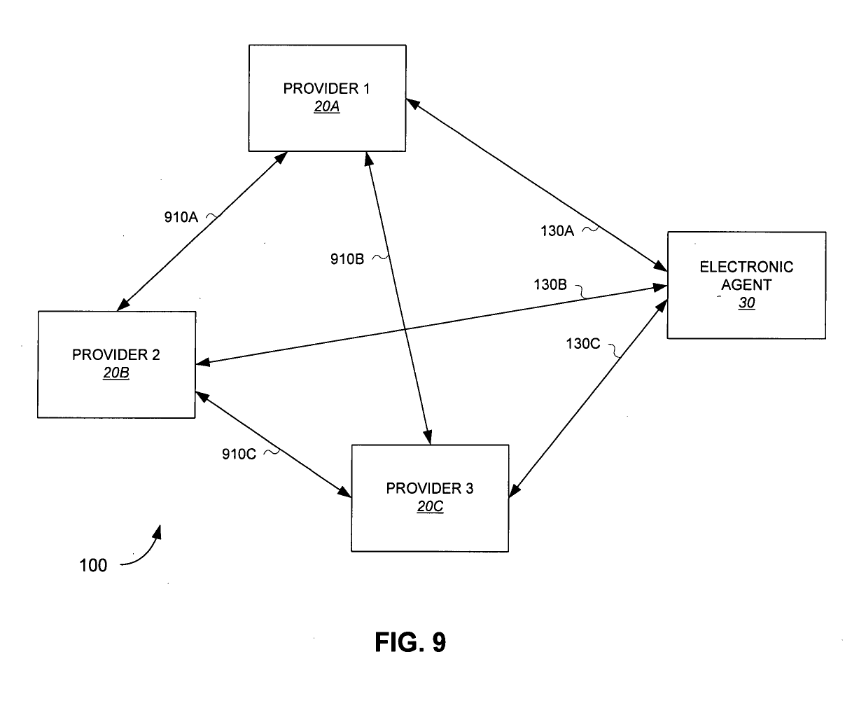

FIG. 9 is an example embodiment of a portion of an electronic personal preference network 100 illustrating intra-provider or cross-provider communication. In this example, provider 1 20A, provider 2 20B, and provider 3 20C may communicate with each other via connections 910A-C. Each provider 20 communicates with electronic agent 30 via connections 130, as described above. As before, electronic agent 30 may transmit permissions of various types to providers 20. Illustrated in this example, electronic agent 30 may give permission to providers 1-3 to transmit customer information between themselves on connections 910. The type of customer information shared between providers, and the authorization to share it, is made in accordance with applicable regulations, and the user's preferences. Any number of data sharing techniques may be deployed. A provider may share all authorized user information per a permission, or may restrict the information shared.

Current privacy laws and complexities sharing data have made it difficult to service customer needs and keep accurate, personalized customer profiles and preferences that can go across companies, divisions, and industries. By using the internet or similar technology, an access/enrollment point can be generated to efficiently gain, manage, control, and update an electronic omnibus (one-for-all) agreement with customers that allows a company to act as a proxy-oriented personal-profile-and-preference-driven electronic agent that turns marketing communication on and off on behalf of the participant. It is distinctive in many areas including the ability for the end-user to customize and change their preferences and profile over time and have those changes in one place impact multiple companies, divisions, industries in a novel automated process. It is also distinctive in that the on-line access would act as an easy start point for the profile and then the profile may be updated in a novel automated process over time based on existing corporate databases and the actual behavior of the end-user as registered in data tracking activities from participating companies.

User information may also be transmitted to electronic agent 30 (i.e. across connections 130) for redelivery to other providers. In this case, electronic agent 30 may be allowed to filter and/or transform user information before providing information to another provider. This may be desirable when providers sharing information do not wish certain aspects of the customer data, i.e. information that the provider considers to be proprietary, with other providers.

Another example illustrating this feature is user medical information. The transmission of medical information is regulated by the Health Insurance Portability and Accountability Act of 1996 (HIPAA). Consider, in this example, that provider 1 is an insurance company, provider 2 is a hospital, and provider 3 is a doctor or local clinic. In order to process payment for a user's medical plan, it may be convenient for these separate entities to share patient information. The patent, i.e. user, may authorize or restrict this as he or she sees fit by controlling user preferences, as described above.

As another example, consider cross-communication between a bank, a mortgage provider, and a broker. Financial services regulations, such as the Fair Credit Reporting Act, and the Gramm-Leach-Bliley Act, prohibit unauthorized disclosure of a users financial information, but the three entities described may choose to offer the user goods or services desirable to the user based on criteria that may be determined only if information sharing is allowed. A user, desirous of receiving such offers, may opt via preference settings to allow this information flow to occur. In one example, unrelated financial services providers may cross-communicate according to permissions assigned by electronic agent 30 in response to preferences. In an alternate scenario, a parent organization may own or have joint marketing programs with subsidiary organizations, which may be trusted already by the user, as indicated by the user's maintaining accounts with all three. The joint organization is unable to cross-market based on user information without the required permissions. So, a user may allow or disallow intra-provider cross-communication as the user sees fit. Thus, coalition members share an electronic backbone that acts as a conduit for information to flow or be stopped according to the preference profile of individual participants.

An example benefit of cross-provider communication risk reduction and/or improved rate setting for financial services companies. For example, by sharing information across providers, more accurate risk profiles may be developed. This benefits the providers, in that risk exposure may be reduced. By closely tailoring premiums with risk exposure, users may benefit from providing permission to share information in the form of lower premiums. This same approach may be applied to health care providers and insurance providers, among others.

Electronic agent 30 may provide information to media companies so they may make advertising more relevant and desirable to participants. Example applications may include direct mail, email, web, phone and Digital Video-Recorders (DVRs). Media companies may tailor the advertising & content shelf space to align with the individual's or businesses' preferences and increase relevance & appeal.

Coalition members may prepare common extracts of information of their customer databases to share the information in a way that facilitates the ability to automate updates to the profile and preferences.

Transaction data may be converted to information that is shared between participating companies. Participating companies may place a monetary value on the data and will track the exchange of information to identify their net monetary balance due to the coalition of participating companies. Automated billing system may be driven by the information exchange. Electronic agent 30 may allow appropriate information sharing and may halt inappropriate information sharing according to the profile and preferences of the participating individual or business, as detailed herein.

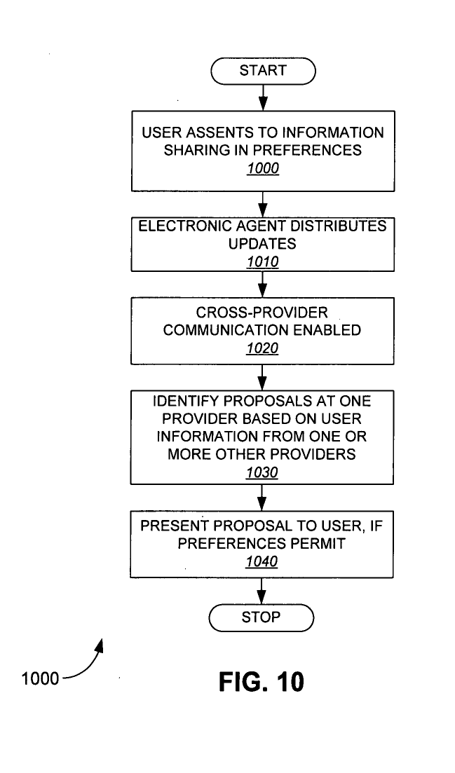

FIG. 10 illustrates method 1000 for enabling cross-provider communication. At 1000, a user assents to information sharing as indicated in the user's preferences. At 1010, as described above, electronic agent 30 distributes updates to applicable providers indicating any changes to permissions that are determined in response to changes in user preferences. At 1020, cross-provider communication is enabled via the respective permissions for one or more providers to share user data, in accordance with the permission. At 1030, one or more providers may identify proposals based on user information from one or more other providers. At 1040, if preferences permit, the proposal is presented to the user to accept or decline the offer. Note that, as discussed further below with respect to activity & offer engine 240, proposals accepted or denied may also be used to deepen user profiles and permissions.

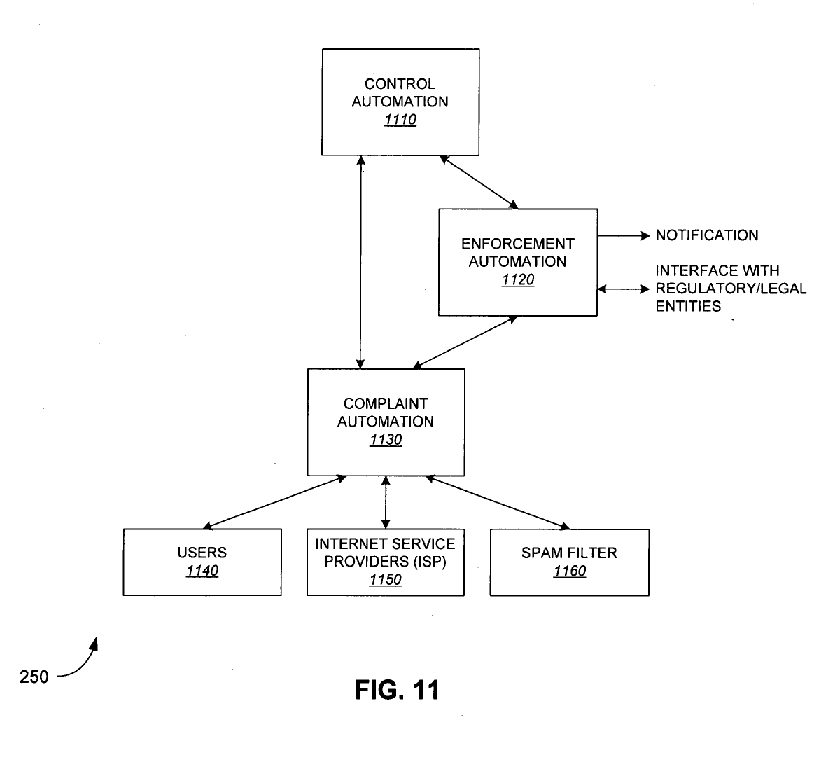

FIG. 11 depicts an example embodiment of enforcement engine 250. This embodiment comprises control automation 1110, enforcement automation 1120 and complaint automation 1130. Enforcement automation 1120 may be used to generate notifications requesting changes in solicitation permissions and may include cease and desist orders to participating coalition members or nonparticipating third party providers. Enforcement automation 1120 may interface with regulatory or legal entities to initiate proceedings and to check the status those proceedings. Complaint automation 1130 provides an automated means for identifying new violators. Complaint automation 1130 may receive notification of a potential violation from users 1140, Internet service providers (ISPs) 1150, or via one or more spam filters 1160. Complaint automation 1130 may receive violator information from various parties as well as provide the same to outside agencies or functions, i.e. ISPs or spam prevention (such as spam filters in email clients, for example). Control automation 1110 may be used to coordinate various methods and procedures, examples of which are detailed below.

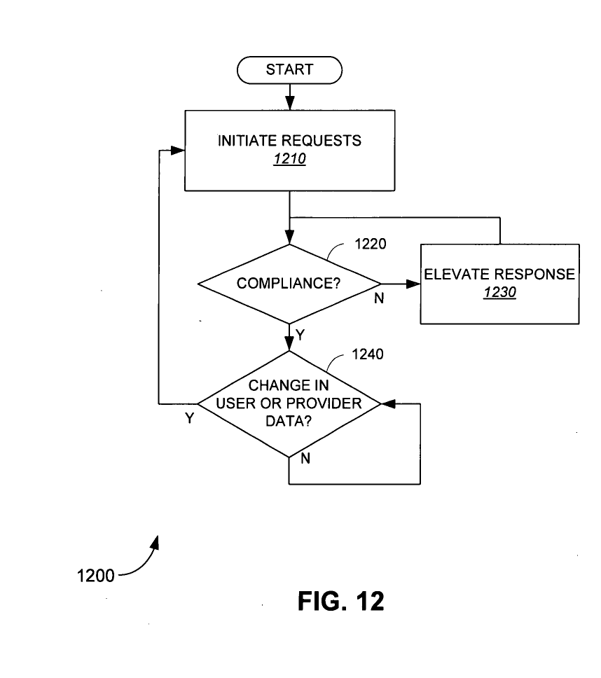

FIG. 12 depicts an example embodiment of method 1200 for enforcement. Method 1200 is suitable for deployment in an enforcement engine 250. At 1210, the enforcement engine initiates one or more requests to a provider for taking action with respect to future solicitation. In decision block 1220, if the provider receiving a request complies with that request, proceed to decision block 1240. If not, at block 1230, enforcement engine 250 may elevate the response appropriately. After elevating the response at block 1230, return to decision block 1220 to determine if the provider is now in compliance. This process may be repeated, as discussed, to elevate the response appropriately based on user preferences, type of violation, etc.

Once a request has been complied with in decision block 1220, proceed to decision block 1240. If a change occurs in user or provider data, such as a preference change for either, as well as changes in the regulatory or legal environment, proceed to block 1210 to initiate a new request, as applicable. If no changes are to be made the process may loop back to decision block 1240 until such a time as additional requests are desired.

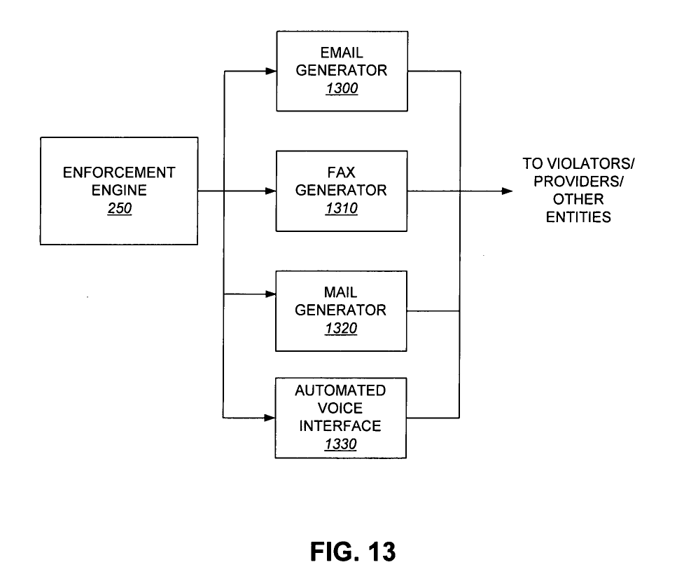

FIG. 13 illustrates various means for generating and transmitting requests to providers including those who are violating either regulations or the terms of the omnibus contract (in the case of coalition members). Enforcement engine 250 is shown connected to a series of example message generators. These components are shown separately for clarity of discussion only. In an example embodiment, enforcement engine 250 may incorporate various communication means, such as those shown, as well as any number of other means for various channels, as will be apparent to those of skill in the art. E-mail generator 1300 may be used to send emails of various type to providers and/or violators. As indicated with respect to FIG. 12, the information in each subsequent email to a repeat violator may contain increasing warning levels and threats. If repeated email attempts (or attempts through other channels) remain unheeded, email generator 13 may be used to send emails to one or more other entities such as a legal service provider or a regulatory agency. Fax generator 1310 may be used in similar fashion as email generator 13, automatically generating faxes as appropriate. Direct mail is an alternate communication channel as indicated with mail generator 1320. Enforcement engine 250 may also use an automated voice interface to place phone calls to providers, violators or other entities as well. [technical means spam jam, phone attacks]

FIG. 13 depicts communication from the enforcement engine (or, in an alternate embodiment, the enforcement component of electronic agent 30), to providers, violators and other entities. It will be clear to those of skill in the art that various messages may be received by an electronic agent as well. Messages may be received in response to initiated request for compliance or to perform various other techniques, as detailed herein.

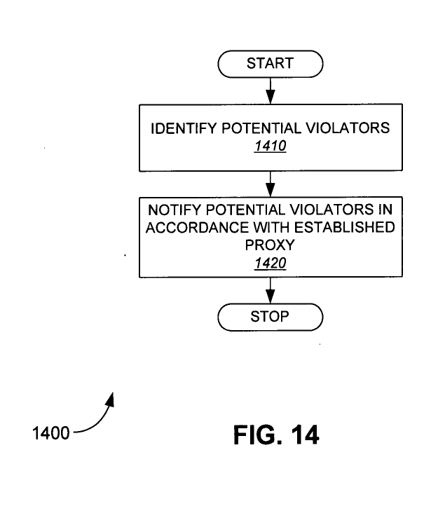

FIG. 14 illustrates an example embodiment of a method 1400 for preemptively enforcing permissions according to each users preferences. For example, a “black list” may be generated using any number of techniques, as described herein. Portions of the black list may be generated and received by outside entities as well. In some circumstances, in which a user has not given blanket permission to receive all or most forms of communication, an electronic agent (including an enforcement engine 250), may preemptively notify each member on the “black list” to cease any communication (on channels as indicated in the user's preferences).

At 1410, where potential violators are identified. This may include a currently known black list which may be added to using any number of techniques such as those described herein. Whenever a new user subscribes to a proxy service provider, such as one deploying electronic personal preference network 100, the electronic agent may initiate a large number of requests to all known violators. Thus, a user, by signing a single contract associated with easily set preferences, may, in one step, send notices to a large number of potential violators, in accordance with current regulations. Providers must comply with the user's request, as conveyed through the proxy given to the electronic agent, or face regulatory and/or legal sanctions. As described above, the process of following up on requests and enforcing requests is also automated. Thus, the user can easily gain great relief form unwanted communication, and/or rely on the fact that enforcement action will be taken. At 1420, the enforcement agent notifies potential violators in accordance with the established proxy.

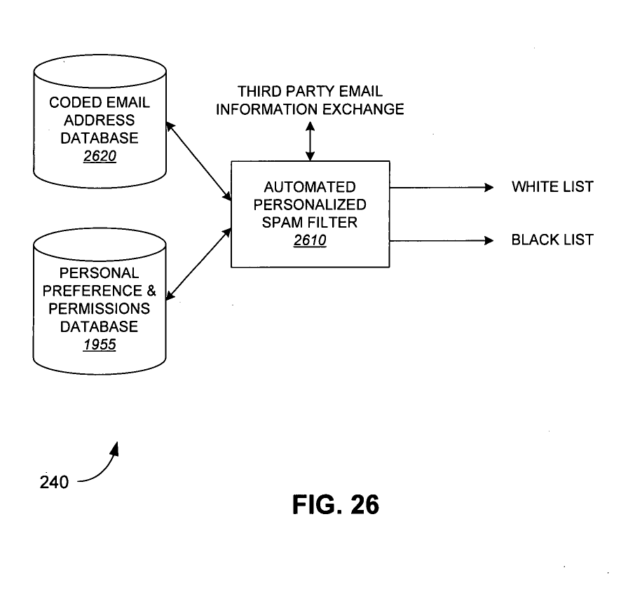

In addition to identifying potential violators, method 1400 may be adapted to identify potential participants as well. So, for example, a “white list” may be formed of participating providers and/or known reputable providers who are likely to comply with requests from the electronic agent. (Black and white list examples are detailed further below with respect to FIG. 26. In this circumstance, if and when preferences are changed, or a new user is added to network 100, white list participants may be notified to generate potential offers, which may be presented to a user with permission, or to present the white list, or a portion thereof, in accordance with user preferences such as industry types, goods, and/or services wanted, types of information prohibited or allowed, etc. In this way, enforcement engine 250 may be used to both deepen and enhance user profiles, expand and refine user preferences/permissions, as well as proactively eliminate unwanted communications while populating a list of potential suitable providers.

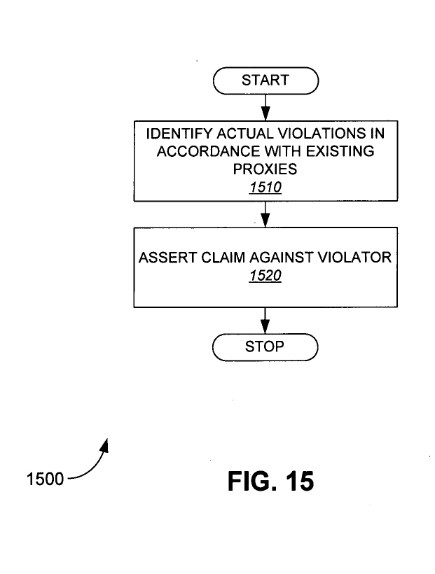

FIG. 15 illustrates an example embodiment of a method 1500 for automating the complaint/violation enforcement process. At 1510, actual violations in accordance with existing proxies and permissions are identified. At 1520, a claim against a violator is asserted using any of the procedures and/or communication channels described above, or additional examples detailed further below.

Violators may be identified using methods that are generated automatically, or by a recipient complaint, or by ISP's, etc, as described herein. An automated violation ID may be formed as follows: A method of automatically identifying violators includes the use of honeypot emails that are fake emails specifically included in the “do not email” list. These emails are specifically created to act as an audit trail for specific receiving companies. If an email is received to that email address it acts as an automated alert that the emailer has sent emails to the list including the fake honeypot alert email. Automated violations may also be secured by requesting a list of phone calls from a company and scrubbing the list of calls to see if they include individuals that had been requested to opt out of any calls.

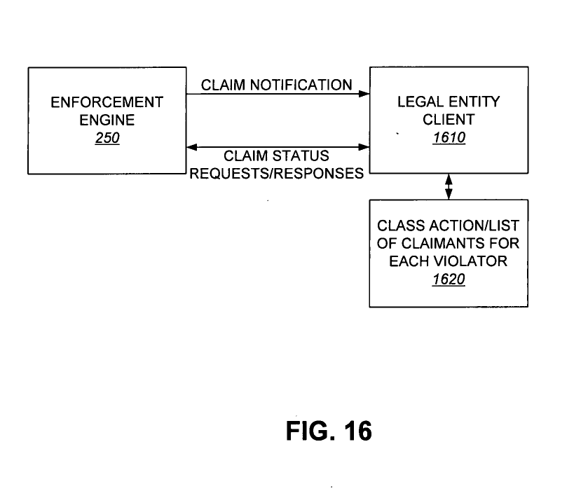

FIG. 16 illustrates an example embodiment of an enforcement engine 250 interfacing with method 1600 for interfacing with a legal or regulatory agency. In FIG. 16, a legal entity is used as an example, but similar techniques may be applied to interface with other regulatory agencies as well. Enforcement engine 250 is connected with a legal entity client 1610. This connection may use network 210 as described above, or any other communication link. A claim notification may be made to legal entity client 1610 to identify a violation of any type. Claim status requests may also be delivered to legal entity 1610. Responses to claim status requests, or updates relating to a claim may be returned to enforcement engine 250. Enforcement engine 250, whether external to electronic agent 30, or a subcomponent thereof, may communicate current status of violations and/or claims for review by users or coalition members, using any of the variety of the user interfaces, as described above. Legal entity client 1610 may utilize any type of client server architecture, or may be a stand-alone software module. In an example embodiment, a legal entity may be a law firm that may join an omnibus provider contract, as described above, agreeing to participate according to the general rules, including any rules specific to legal entity providers. A regulatory agency client may participate similarly. Alternately, a legal entity, such as a law firm, regulatory agency, or other enforcement agency may enter in to separate agreements with electronic agent 30 as well.

Note that electronic agent 30 has been authorized according to the proxy given by the omnibus contract between the user and the electronic agent (and/or the proxy service provider comprising the electronic agent) has been given the authority to act on behalf of the user in filing any claim, complaint, notice or other proceeding with a law firm or regulatory agency.

Legal entity client 1610 may also automate the process of entering into any further contracts and/or establishing attorney/client privilege with users, as need be, by automating the process through electronic agent 30 and presenting required proposals/contract for review and acceptance by one or more users.

In addition, a class action (or list of claimants for each violator, as shown at 1620, may be maintained. This allows automated aggregation of class participants for each violator as well as automating the process of maintaining claims against multiple violators. Legal entity client 1610 (or any regulator agency client) may interface with various components detailed herein, to facilitate claim prosecution, such as verification with a compliance clearinghouse and/or regulatory rules engines and databases to verify claims and/or identify pertinent parameters of each claim such, as damage amounts, penalties, notice requirements, etc.

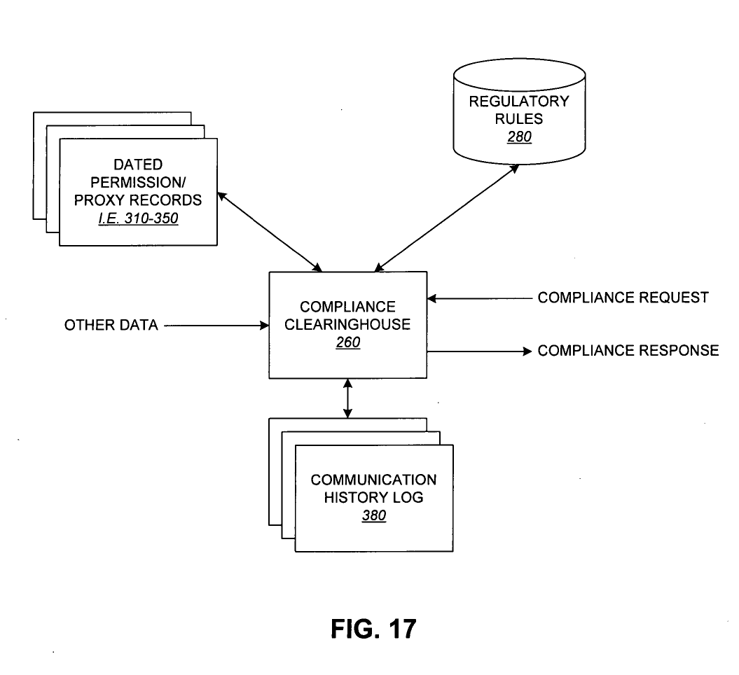

FIG. 17 depicts an example embodiment of compliance clearinghouse 260. In this example, a compliance request is made to compliance clearinghouse 260. After processing the request, a compliance response is generated. The request and response may be delivered over network 210, in an example embodiment, or via any other connection. Various types of components and/or parties may wish to access a compliance clearinghouse 260. For example, a provider may wish to verify that past communications to one or more users have been in compliance. This may be done as part of an audit process. To avoid liability, a provider, in certain circumstances, may wish to perform a compliance check for a certain type of communication to one or more users prior to sending that communication. Regulatory agencies and/or legal entities may wish to have a mechanism by which to determine whether or not a communication was in compliance with either the contractual agreement forming the proxy and the coalition agreement, as well as any applicable regulations.

Any type of compliance request may be employed. For example, a compliance request may indicate a particular user, and a compliance response indicating whether the provider has complied, for example, in all communications to that user. As another example, a provider may request compliance for all communications of a certain type. Responses may be made corresponding to the various types of requests. A database of applicable rules 280, may be connected to compliance clearinghouse 260. A list of current example legislation applying to communications is included in Table 1 below.

TABLE 1
Current Regulations

| | |
|---|---|
| Congressional “CAN SPAM | Overrides state SPAM laws: requires all |
| Act” S.877 (Jan. 1, 2004) | emails to clearly identify subject and |
| | have traceable source |
| | Places burden on sponsoring company, |
| | rather than email vendor |
| | Requires Opt-out for all unsolicited |
| | emails |
| | Large consumer groups are already |
| | calling for congress to create more |
| | severe legislation |
| Fair Credit Reporting Act | Prevents states from limiting affiliate |
| | information sharing. Congress voted to |
| | extend, President Bush signed |
| | December 2003 |
| | New law now requires opt-out for all/ |
| | any marketing including affiliates |
| | Consumers union has asked congress to |
| | reconsider affiliate sharing. |
| Gramm-Leach-Biley Act | Established rules for financial service |
| (GLB in 1999) | data exchange |
| FCC “Do Not Call” Rule | Only covers 25% of calls |
| | Does not apply if there is an existing |
| | relationship in the past 18 months |
| | Experts expect consumer advocates to |
| | push for more severe laws |
| FCC New Telephone Act | Written permission required for all |
| (TCPA Rules) (Jan. 1, 2005) | faxes |
| | $11,000 fine for all faxes |
| EU Electronic Communication | Imposes similar restrictions on the use |
| Directive | of email for commercial purposes, |
| | business-related e-mail messages from |
| | or to the countries in the European |
| | Union (October 2003) |
| U.S Federal Law (39 U.S.C. § | Gives individuals the “unfettered” right |
| 4009) | to stop any non-governmental organiza- |
| | tion from sending further mail |

Dated permission and proxy records (i.e. 310-350), detailed above, may be made available to compliance clearinghouse 260 for determining whether a communication was in compliance with contractual obligations. A communication history log may be connected to facilitate compliance requests for communications that have transpired in the past, such as historical log 380. Those of skill in the art will recognize that any number of rules, databases, permission and proxy records or communication logs may be connected to a communication clearinghouse. For example, a record of communications, stored at the provider's location, may be made available through an interface to compliance clearinghouse 260 to facilitate compliance requests. As an additional example, location data may be provided to assist in selecting which regulatory rules 280 to apply.

There may be different jurisdictions and/or local rules applicable to various types of communication on different channels. Other data may also be delivered to aid in determining what rules and/or permissions may be applied in determining compliance. Other data required for compliance determination, may also be included with a compliance request or through a different connection.

Thus, an electronic process for streamlining regulatory and legal compliance with privacy requirements is provided.

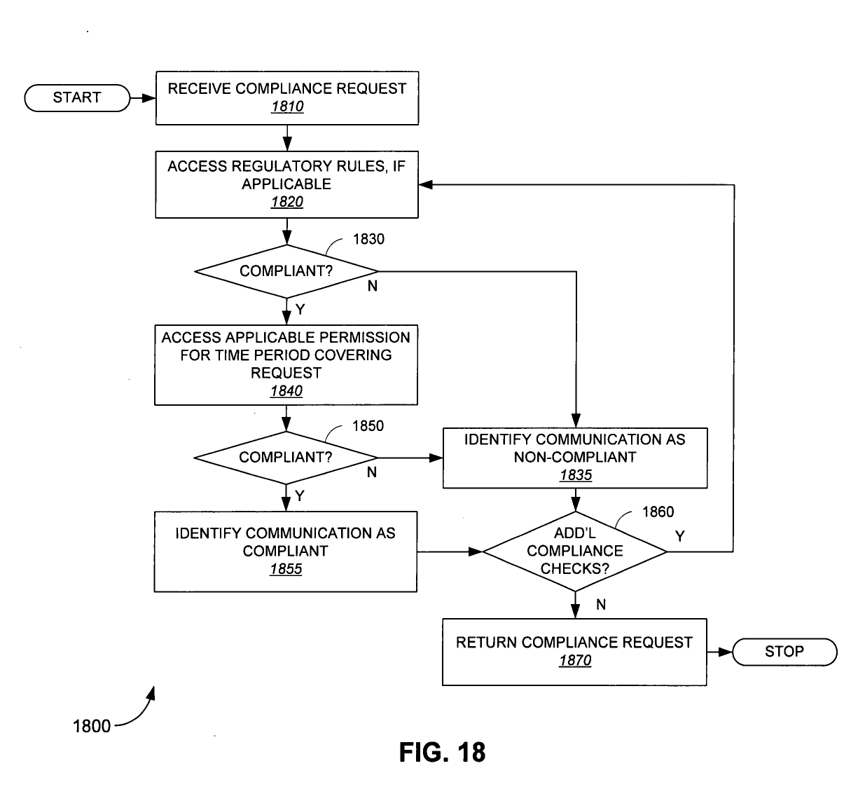

FIG. 18 depicts an example embodiment of a method 1800 for performing a compliance clearinghouse function. At 1810, a compliance request is received. Various types of compliance requests may be processed, as described above. For example, provider may request compliance verification for historical communications, where the communications may include those specific to a user, those specific to a communication type (i.e. channel, goods or services offered, marketing promotion etc.). In addition, a compliance request may also be made from a regulatory agency or legal entity in order to assist with processing complaints and/or violations, etc. Cross-provider communication checks may also be performed using compliance clearinghouse 260. For example, prior to sending, receiving, or using information subject to privacy laws and/or other regulations, a provider may use the compliance clearinghouse function to determine if such a communication, or use of data, would comply with existing regulations, existing contractual obligations, and customer approval of such data sharing, as described above with respect to FIGS. 9 and 10.

As described above, a compliance request may be for a single communication to a single user, or a batch of communications of various types, including those to more than one user. 1820-1860 may be repeated for each applicable communication in the request. At 1820, applicable rules (for the applicable time period) are accessed. In decision block 1830, a determination is made whether the communication is compliant. This determination will include any applicable rules accessed and may also be made in accordance with other data such as jurisdiction, location, local rules, or other attributes of the user (i.e. age). If a communication is found to be compliant, proceed to 1840. If not, identify the communication as non-compliant in 1835, then proceed to decision block 1860 to determine if additional compliance checks remain to be tested in the compliance request.

At 1840, applicable permissions for the time period covering the request are accessed. These may be retrieved from dated permission proxy records, i.e. 310-350, detailed above with respect to electronic agent 30, in FIG. 3. In decision block 1850, a determination is made whether the communication being tested is compliant with the contractual obligations, including the user preferences as well as provided preferences (when provider preferences are more restrictive than regulatory or the users preferences). If the communication is not compliant, proceed to 1835 to mark that communication as non-compliant, as described above. Then proceed to decision block 1860 to determine whether additional communications remain to be checked. Note that additional information may be recorded to identify the type of violation, whether regulatory, outside of user preferences, outside of provider preferences, invalid permission, permission expired, or permission not covering cross-communication data exchange, and the like.

In decision block 1850, if the communication is determined to be compliant proceed to block 1855 and mark the communication as compliant. Proceed to decision block 1860 to see if additional compliant checks remain to be performed. If so, proceed to block 1820, described above. If all communications for the current clients requests have been processed, return a compliance response at 1870, including any detail desired for each complying or non-complying message in the batch, if more than one communication was checked.

Note that, when checking compliance, i.e. in decision block 1850, compliance clearinghouse 260 may, if desired, re-check permissions to see that they were valid in context with user preferences at the time. Note further that regulatory rules 280 may need to include historical versions to determine the appropriate piece of legislation or code valid at the time of a historical communication.

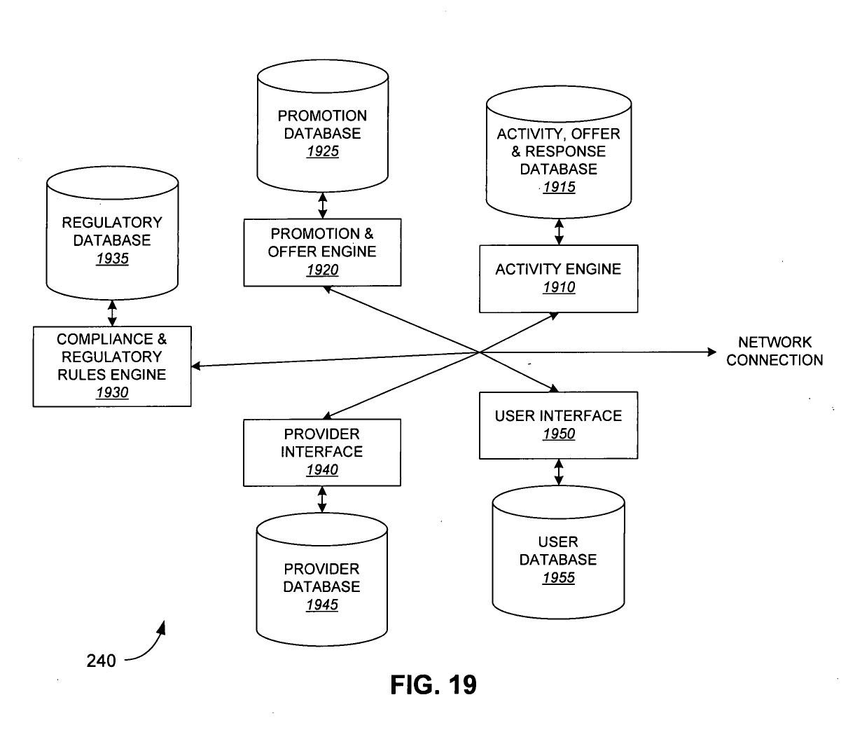

FIG. 19 depicts an example embodiment of an activity & offer engine 240. This example activity & offer engine 240 comprises several modules and associated databases. Each module, in this example, is interconnected to provide cross-functionality as well as connected to an external interface such as network 210 to provide an interface to various other functions. Activity engine 1910 comprises business rules and software to automate the process of driving, tracking, recording and storing activities. Activities may be stored in activity, offer and response database 1915, which is shown connected to activity engine 1910.

Promotion & offer engine 1920 automates the process of sending relevant offers based on permission and preferences, examples of which are detailed further below. Additionally, this engine may automate the function of creating and managing offers across participating companies. This engine drives, tracks, stores, records and responds to activity. Promotions, offers, responses activities, and the like may be stored in promotion database 1925, which is shown connected to promotion & offer engine 1920.

Compliance & regulatory rules engine 1930 comprises, for example, federal and state regulations data, as well as participating provider policies and rules. Compliance & Regulatory rules engine 1930, in conjunction with regulatory database 1935, is used to determine compliance with applicable regulatory regimes for the various promotions, offers and communications that may be generated in activity and offer engine 240.

Provider Interface 1940 allows a provider to specify permissions and preferences. These may also be imported from the corresponding segment of electronic agent 30, in an embodiment in which activity & offer engine 240 is not combined with electronic agent 30. A provider may create and/or respond to offers matching their preferences from other companies via the electronic personal profile network, as described above. A provider may create offers for individual users. A company may create data extracts and/or preference information for selected customers, and provide this information to other providers and/or the electronic agent 30, in accordance with user defined preferences and associated permissions. Provider information may be stored in provider database 1945, shown connected to provider interface 1940.

User interface 1950 allows a user to specify user permission and preferences, as well as to respond to offers generated. Note that these functions may also be carried out in electronic agent 30, in an alternate embodiment. The users permissions and preferences, as well as responses to various offers, may be stored in user database 1955. Additional profile information may also be stored in user database 1955, as described in various examples herein.

The activity & offer engine 240 may be used to perform several functions. First, permissions may be deepened automatically by associating new providers and/or new offers with already existing preferences to increase permissions available, providing a user with information and offers that may be of interest, as well as increasing the likelihood of response (which is of interest to most providers). Second, preferences may be automatically deepened as well, as a user responds to potential offers, which are tailored to the user's preferences. Third, offers are generated in accordance with the permissions and preferences, as well as various other techniques, examples of which are detailed below.

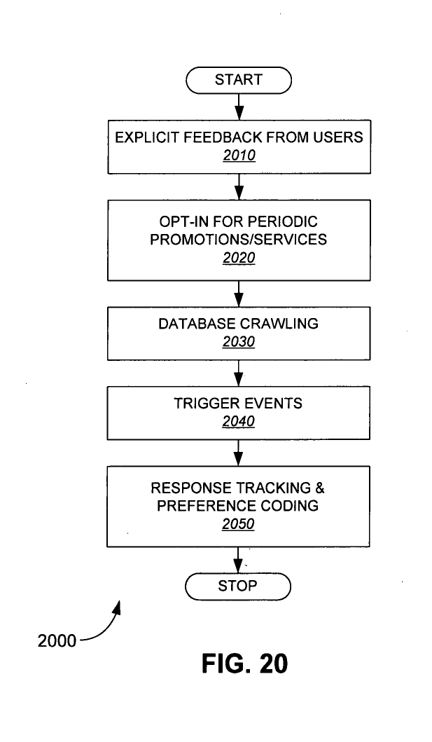

FIG. 20 illustrates an example embodiment of a method 2000 illustrating various activity & offer engine activities. These are not exhaustive, but serve to illustrate various types of techniques for deepening profiles and permissions and generating relevant offers. At 2010, activity & offer engine may receive explicit feedback from users. This may be performed via the user interface (i.e. 212), entering references explicitly. It may also include a user's response to specific change offers that may be generated.

At 2020, the user may opt-in for periodic promotions and/or services, in response to various communications generated from providers, as well as presented by electronic agent 30, as applicable. In one example, a user setting may allow for periodic (i.e. weekly or monthly) presentation from the electronic agent of offers deemed to be potentially relevant to the user. The user gets the benefit of not having to weed through numerous presentations, rather accepting or declining offers, according to interest, from a digest of highly relevant offers. Naturally, a user may turn this feature off if he or she does not wish to have periodic offers, and the associated benefits of automatic preference update.

At 2020, database crawling may be deployed to retrieve user information, such as past purchases, or other indicated preferences from other provider's databases. This information may be shared according to preferences between various coalition members. Crawling may be carried out using a data extract technique, in which a provider may keep a pre-determined portion of data proprietary, while releasing certain information that is of value to other providers. Providers may pay fees for such extracts, and/or may trade data extracts. Database information from one or more providers may also be delivered to electronic agent 30. Insofar as electronic agent 30 is a neutral party, providers may be interested in allowing electronic agent 30 to crawl joint databases or extracts therefrom, in order to determine joint marketing opportunities, aggregated data trends, or identifying users who may be particularly interested in receiving information about a specific product or service. A unique user ID, as described herein, may be used during various crawling procedures to correlate transactions and/or information with users.

At 2040, trigger events may be used to identify target users for potential offerings that may be particularly relevant in a certain phase of life. Example trigger events include the birth of a baby, a home purchase, a car purchase, death of a spouse, a change in health status, etc. According to permissions set by the user, in accordance with regulations, providers may sell information to other providers in order to allow trigger event identification and tracking, as well as for targeted marketing communications associated with those triggering events.

At 2050, a user's responses are tracked and preference coding is generated. A preference code may be used to automate the process in keeping preferences current and relevant. They also reduce the data storage requirements and may help manage privacy issues. Various preference codes may be determined to identify individuals with certain types of tastes and/or preferences. For example, people who like one set of products may be identified by one preference code and people with other interests may be identified by another preference code. Combinations of interests may be given unique codes, if that information is useful for generating specific types of offers and generating well-tailored permissions for preferences.

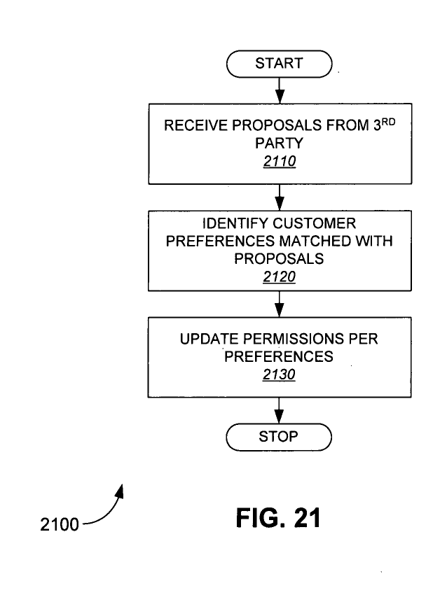

FIG. 21 depicts an example embodiment of method 2100 for automated permission updating. At 2110, proposals may be received from various third parties, including coalition members and other providers. At 2120, matches between customer preferences and received proposals are identified. At 2130, permissions for various providers are updated in accordance with preferences when a match has been identified. In the situation where users allow such updating (or, in the alternative, don't prevent such updating), then the user permissions may be deepened automatically without user intervention.

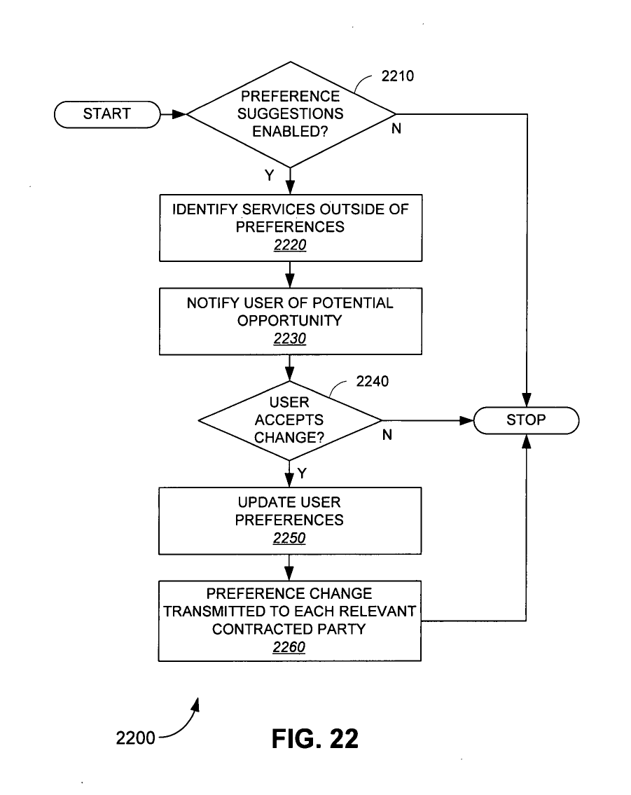

FIG. 22 depicts an example embodiment of a method 2200 for automated selection and notice of potential relevant services. In decision block 2210, if a user has enabled preference suggestions, proceed to 2220. If not, the process may stop. At 2220, services (including various offers for products), which are outside of the current user preferences, are identified.

At 2230, the user is notified of one or more potential opportunities, as identified. Note that the regularity of such notification may be limited by the user in accordance with the user's preference. For example, a weekly or monthly update may be allowed. Other users may allow a daily update, or updates as frequently as services are identified (for example, if other preferences are tailored tightly so that only certain offers get through, a user may be willing to allow those offers to be presented at their earliest convenience). In the notification, the user may be given an opportunity to accept or reject a change to preferences based on the offer. For example, a particular offer for a relevant good or service may be presented, the user may select to see that offer, but not change preferences. Optionally or alternatively, the notification indicates that offers such as this are being suppressed, and the user is given the opportunity to change his or her preferences.

In decision block 2240, if the user accepts the change, proceed to 2250. If not, the process may stop. At 2250, the user's preferences are updated. At 2260, the preference change is transmitted to each relevant contracted party. Thus, for example, various permissions may need to be added, modified, or deleted, and messages sent to those providers for which permissions exist and have been changed, as detailed above with respect to FIG. 7.

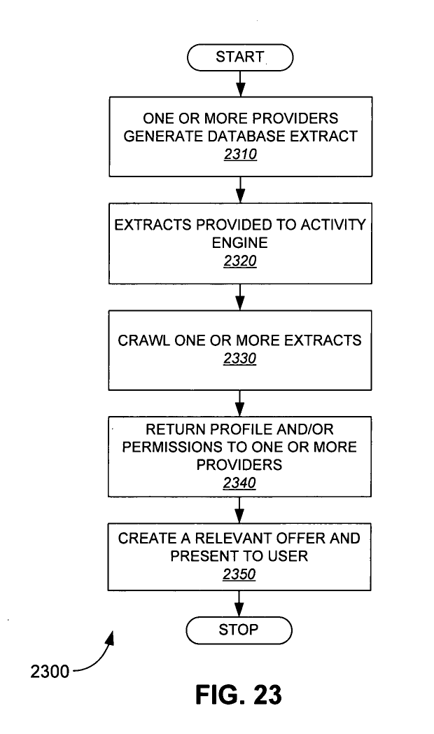

FIG. 23 depicts an example embodiment of a method 2300 for automated database crawling, such as described with respect to 2030 above. At 2310, one or more providers generate a database extract. In an alternate example, one or more providers may make their database available in its entirety, or may make a portion of their database searchable via an external interface. At 2320, extracts (or the alternates just listed) are provided to an activity engine such as offer & activity engine 240. At 2330, one or more extracts may be crawled (i.e. searched to correlate users using information such as previous transactions, interests, identification of users as clients of particular services, etc.). Note that the current profiles and preferences stored in, or in connection with, to electronic agent 30 may also be crawled or reviewed for additional profile information. This is another example of automated profile deepening.

At 2340, a profile and/or one or more new permissions to one or more providers may be returned. In one example, providers are given information for communication to users and identification of those users. Those providers understand, according to their previously determined preferences and agreements with the electronic agent, as well as other participating coalition members, that the users returned will meet certain criteria, and are likely targets for the type of message being delivered. In an alternate embodiment, a profile of those users may be delivered, which a provider may use for future communication in accordance with permissions, and may combine with other information known by the provider to tailor the marketing offer and/or message to the user. 2310-2340 identify profile deepening.

At 2350, an offer may be created and presented to the user identified as likely relevant. This offer may be presented by the electronic agent, or in accordance with permissions granted to one or more providers. Note that, in each of these offer opportunities, combinations of various techniques may be deployed. For example, in any offer presented to a user, whether by electronic agent 30, or by a participating provider, an option to accept changes based on that offer may be presented, or alternate offers may be presented (perhaps in relatively small fields surrounding the permitted offer), if such automated preference enhancing techniques are allowed according to user preference.

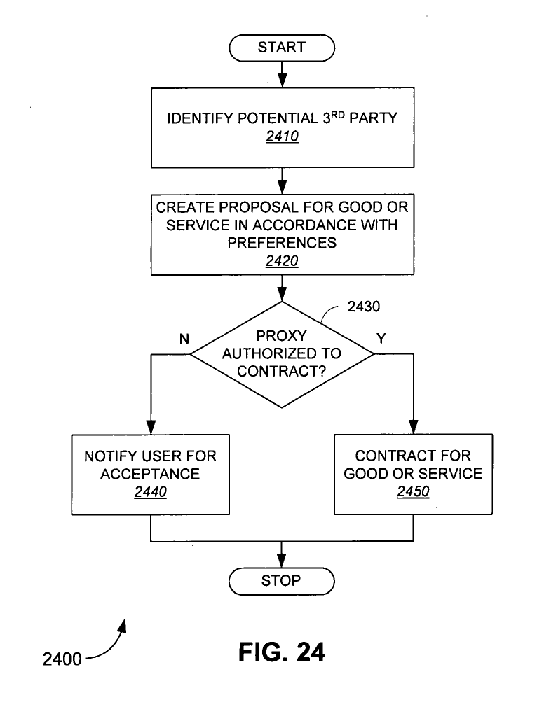

FIG. 24 illustrates an example embodiment of a method 2400 for automated contract creation based on preferences, permission and proxy. At 2410, a potential third party is identified by the electronic agent. At 2420, the electronic agent creates a proposal for a good or service in accordance with preferences. For example, a user may explicitly indicate to the electronic agent that a particular type of offer may be desired. For example, a user may be in the market for a car and is willing to accept offers within the price range on the types of cars specified. In addition to agreeing to receive offers, their may be certain goods or services in which the user contracts into a delivery or performance of a good or service. Proposal creation may also be automated when a user has indicated certain preferences, the electronic agent determines a potential proposal and presents that proposal to the user. If the user desires to enter into a contract for that service according to the terms, the user may authorize the electronic agent to seek a suitable match for that good or service. Decision block 2430 identifies the option to allow or disallow proxy authorization to contract. If the electronic agent is authorized to contract, then, at 2450, a contract for the good or service is entered with the electronic agent acting on behalf of the user entering the contract with the provider. Note that contracting may be limited to contracts between users and coalition members, or may be generalized to contracts between users and any other party. In decision block 2430, if a proxy is not authorized to contract, the electronic agent, after having located a suitable match for the proposal may notify the user of the match and await the users acceptance or rejection of the contract. In this case, an electronic contract may be presented for electronic signature by the user. Thus, the good or service may be contracted in a two step process.

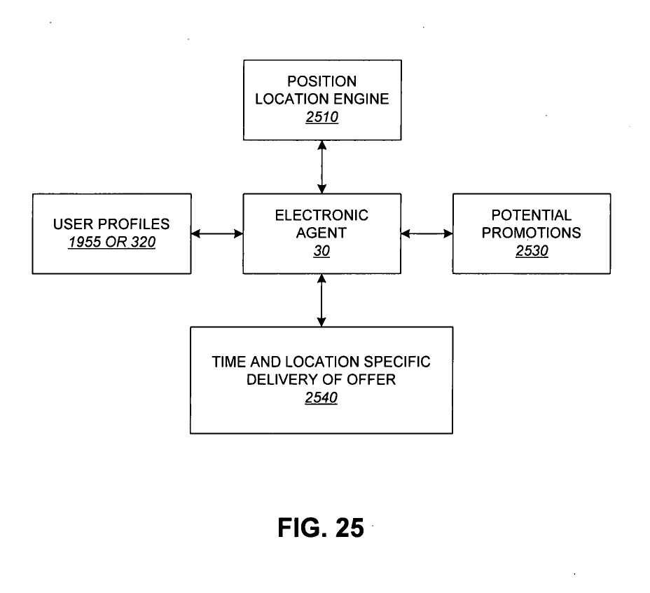

FIG. 25 is an example embodiment of an electronic agent 30, illustrating using position location in accordance with profiles and permissions to generate time and location specific delivery of more relevant and desirable services and/or offers. Electronic agent 30 may incorporate activity & offer engine 240, in the embodiment detailed. In an alternate embodiment, the techniques described with respect to FIG. 25 may be carried out in activity & offer engine 240. User profiles, i.e. those stored in user database 1955, or user preferences database 320, are connected to electronic agent 30. A position location may be delivered to electronic agent 30 from position location engine 2510. Various techniques for determining position location are known in the art. For example, a user may use a cellular telephone, which may use the Global Positioning System (GPS). Any position location system or technique may be deployed to deliver a position location to electronic agent 30.

Customer promotions 2530 may be generated, using any of the techniques detailed herein, for providing potential promotions to electronic agent 30. Promotions may be from a single party, or may be joint marketing efforts from one or more organizations, such as coalition members. Electronic agent 30 performs rule-based operations to determine when an offer should be made to a user, in accordance with the user's preferences and permissions, the user's location, and the parameters of the promotions available. At 2540, a time and location specific delivery of services and/or offers may be made to users.

FIG. 26 depicts an example embodiment of an automated personalized spam filter 2610. The components depicted may be incorporated in an activity & offer engine 240, as described above. A coded email address database 2620 is connected to the automated personalized spam filter 2610. Automated personalized spam filter 2610 automates the process of creating and updating black list and/or white list of email addresses, for the specific individual, based on proxies, preferences and permissions. This database includes an archive of all known emails, or a link to third parties for supplying that information, as indicated. Various procedures, such as those detailed herein, corresponding to electronic agent 30 may also be used to populate coded email address database 2620. Coded email address database 2620 includes coding for reference to identify various email addresses. An example coding designates each email as white, black or gray. A potential white email address is a candidate for a white list. A potential black email address is a candidate for a black list. A gray candidate will be determined as white or black in accordance with a user's preference and profile. Coded email address database 2620 may include software and rules to automate the process proactively updating databases for individual and company use.

Personal preference & permissions database, i.e. database 1955, detailed above, is connected to automated personalized spam filter 2610 to identify the level of access preferred for specific channels and companies. In this example, the channel being described is email. White and black lists generated by automated personalized spam filter 2610 may be used to proactively update an individual's database at the ISP level, spam filter level, and/or email software level. In addition, as detailed above, electronic agent 30 and/or automated personalized spam filter 2610 may proactively contact responsive companies to stop emails at their source, before they are sent, based on the proxy permission of the individual user and associated preferences.

As just described, third party email information may be exchanged for use in populating coded email address database 2620. Note that, in general, black list generation is an ongoing task, as spam email senders continually update their addresses to try to thwart attempts to filter their marketing messages. Thus, white lists may prove to be useful in context where black lists are difficult to maintain. For an email sender, to maintain a good reputation is much more difficult than for a spammer to change its email address. White and black list output may also be delivered to other entities or agencies, to assist in populating archives of known email addresses. When a user accesses email, delivered email may be identified as unwanted email, in which case the address may be removed from the white list. Similarly if a desired message is delivered to, for example, a bulk email filter, a user may identify the sender as a desirable communication provider, and the email address may be placed on the white list for that user. These white and/or black list updates may be fed back to automated personalized spam filter 2610.

A “black list’ database of known “junk” marketers may be generated to support the preemptive sending of requests to stop marketing activities across relevant channels with specific companies. This is driven according to the individual preferences and the proxy permission to stand in on that individual's behalf and preemptively tell the black list company to not contact the individual. Historically, this can be done by an individual, manually, but it is a burdensome process and requires knowledge of who and how to contact theses junk companies in an effective way. As described herein, black list generation is automated.

A “white list” database may be generated based on permissions and preferences that includes a means of automating white lists for email, cell phone, text messaging, etc. This functionality may include the use of the proxy to provide an automated method of selecting which companies should be allowed to contact the individual, in which channels and providing a means of automating the compliance with any legal regulations or corporate policies regarding the contact. For example, a purchase on Amazon. COM may trigger an update to an electronic clearinghouse that may send an update to the “allowed emails” profile for that individual. Updates may be tailored based upon personal profile preferences of that individual and then provided to the individual's “allowed emails” file.

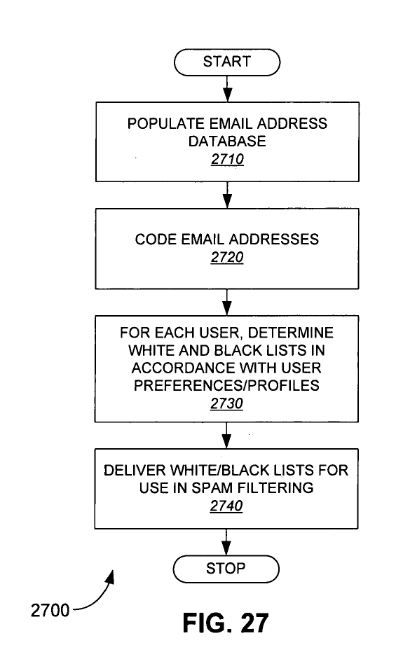

FIG. 27 depicts an example embodiment of a method 2700 for automated personalized spam filtering. At 2710, an email address database is populated, such as coded email address database 2620, described above. This database contains an archive of all known email addresses and may be populated using any of the techniques described herein, including those described with respect to electronic agent 30, and/or other activity & offer engine 240 activities. At 2720, the email addresses are coded. In an example embodiment, the coding may indicate potential white list candidates, potential black list candidates, and potential gray list candidates. Potential white list candidates are presumptive allowable email addresses, and potential black list candidates are presumptively denied access. At 2730, for each user, a white and black list is determined in accordance with user preferences. Presumptive white and black list email addresses are placed on the white and black list, respectively, in the absence of a user preference specifying otherwise. Gray addresses are processed in accordance with user preferences and profiles to determine whether they should be placed on the white list, and access allowed, or placed on the black list with access denied. At 2740, the white an/or black lists are delivered for use in spam filtering, as detailed above. For example white and/or black list may be delivered to an ISP, used in a spam filter (i.e. a spam filter service provider), and/or email software (i.e. an email client program).

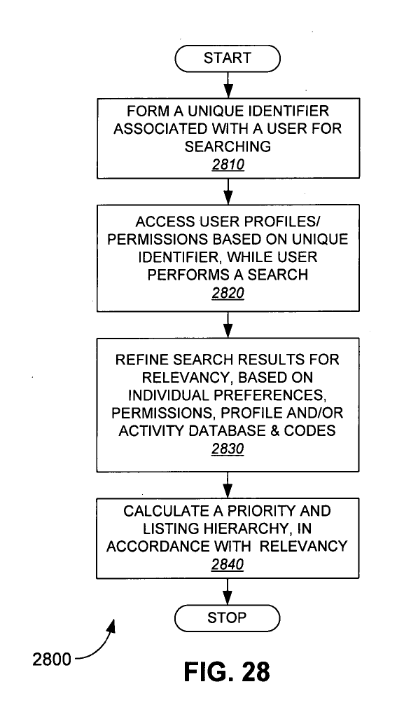

FIG. 28 depicts an example embodiment of a method 2800 for enhancing searching, based on preferences permissions and profiles. Search engines are well known in the art. Users visit websites of search engine providers, or other websites including search engine functionality (which may be private labeled for one of the aforementioned search providers). Search results are generated in accordance with a variety of search technologies. For a given user query, a hierarchical and prioritized listing of search results is typically presented. Search results may be presented in order of highest relevance, or based on payment by providers, or various other techniques, or a combination of the above. For the same reasons given above, providers with a marketing message, trying to reach users, would like to have their messages tailored and relevant to the user, in order to increase user receptivity. Users generally wish to find relevant offers as well, when performing various searches. Thus, a search engine is another useful embodiment in which to incorporate various aspects, as detailed herein.

At 2810, a unique identifier is formed for each user for use in searching. This identifier may be unique to search, for security purposes (and more than one identifier for a user may be allocated to various search providers.). Alternately, a unique ID identifier, as detailed herein for use with various other functions, may be used. In the context of search, a subclass of web based communication, example techniques for forming a unique identifier include setting cookies, a logon process, and the like. Any technique for associating a search user with that users profile and preferences may be deployed.

At 2820, when a user performs a search, access the user's profiles and/or permissions based on the unique identifier. A variety of techniques may be deployed for providing access. For example, user preferences, profiles and permissions, such as those detailed with respect to electronic agent 30, for example, may be securely accessed via a network, i.e. network 210 (any other component, such as those depicted in FIG. 2, may be accessed for performing various functions as described above). Another technique is to proactively upload preferences and profile data to the search service provider, along with user identifiers, so that the search provider may keep that data secure and access the preferences, profiles and permissions as needed. A combination of these two techniques may also be deployed. A search engine provider may become a coalition member. In general, a search engine may comply in whole or in part with the omnibus provider contract (and may be required to do so, in certain embodiments).

At 2830, search results, received using any search technique, in response to the query initiated at 2820, is refined for relevancy based on individual preferences, permissions, profile and/or activity database and codes (i.e. activity offer & response database 1915, detailed above).

At 2840, a priority and listing hierarchy for displaying search results is calculated. As described above, current search processes may use a bidding procedure to determine based on a rank ordering of bids the listing of search results. In this example search results may be listed by relevance only, incorporating unique personalization process based on preference, permission, profile and/or activity databases and codes. In an alternate example, priority and listing hierarchy may be computed as a combination of corresponding bid amount as well as a relevancy to the requesting individual, as determined at 2830. For example, a first parameter may be determined to indicate the relevance level of a result, based on the user's personal information, as described above. A second parameter may be determined to indicated the priority level of a search result, based on bidding, for example (any other hierarchical ordering scheme may be used to determine this second parameter). Then, the search listing order may be determined as a function of the first parameter and the second parameter.

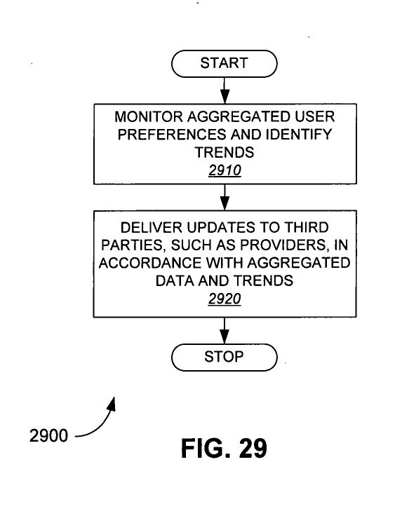

FIG. 29 is an example embodiment of a method 2900 for monitoring aggregated user preference trends. Electronic agent 30 may be uniquely suited to receive valuable information about users and providers within electronic personal preference network 100. As described above, with the appropriate permission, and within regulatory requirements, user information may be shared between parties. In addition, it may be desirable to aggregate trends in user feedback, such as responses to various marketing communications. At 2910, monitor aggregated user preferences and identify trends. For example, responses to offers and changes in preferences may indicate receptiveness to various offering types. At 2920, deliver updates to various third parties, such as coalition members, or other providers, in accordance with aggregated data and trends.

FIG. 30 depicts an example embodiment of a user interface 3010 (i.e. web browser) for entering a user proxy agreement. A summary of key terms 3020 is presented to facilitate understanding by the user, and may be required to make the contract enforceable in some jurisdictions. The complete text of the contract is provided in scrollable window 3030. Once a user has agreed to the terms of the contract, the user may assent to those terms and enter the contract by selecting agreement button 3050. If the user does not agree to the terms of the contract, the user may decline by selecting button 3040. There may also be an electronic signature process that is employed and the results registered (as appropriate for the jurisdiction, type of communication, regulations, etc.)

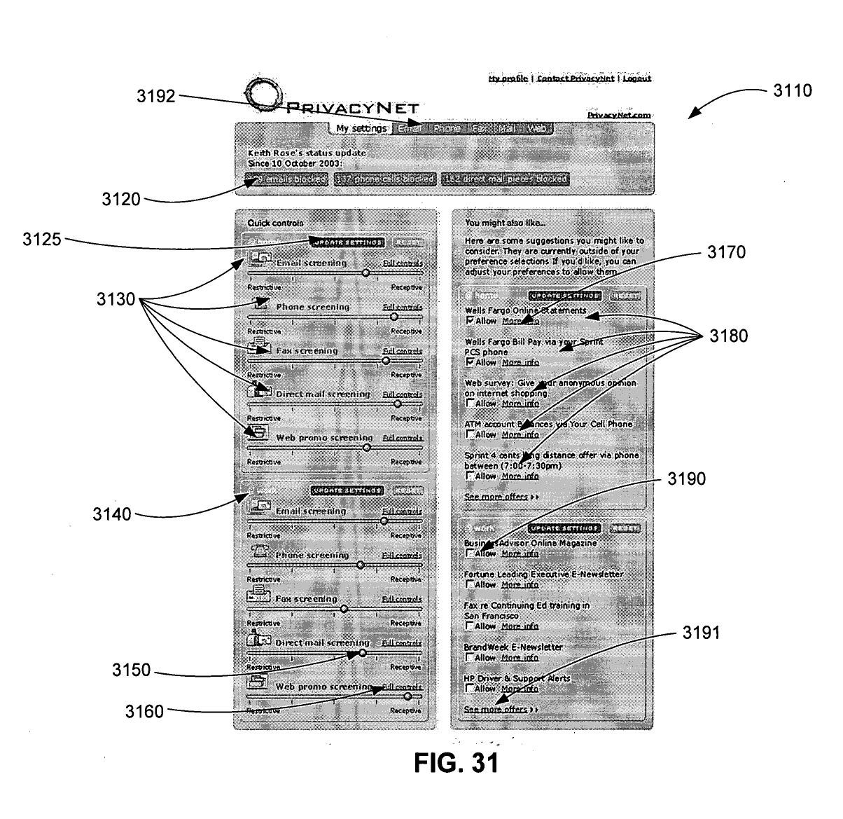

FIG. 31 depicts an example embodiment of a user interface 3110 illustrating preference control, offers, and example statistics. Users may provide electronic proxy-oriented permission and preferences via an electronic means for electronic agent 30 to act on their behalf and automate the process of eliminating undesired marketing materials (email, web, paper, fax, advertising, etc.) and/or automate the process of providing permission for specific companies to use their data for the benefit of participants, as described above.

Categories 3130 allow the user to automate the process of setting preferences and permissions across channels 120. In this example, channels for which a simple slider may set preferences include email, phone, fax, direct mail, and web. Additionally, drill down tabs 3192 are available to access additional detail, allowing the user greater control over specific preferences. An alternate personality 3140 illustrates the use of multiple preference settings for home and work. The preference for a category may be set by adjusting slider 3150. Alternatively, full control may be accessed by selecting link 3160.

An update button 3125 is provided in this example to indicate that the user has completed modifications, and authorizes the changes made in accordance with the proxy contract. Electronic agent 30 is then free to update and perform various tasks, such as those detailed above.

Proposed offers to update preferences 3180 may be presented if the user has allowed. By reviewing and accepting an update proposal, by checking 3190, preferences may be automatically expanded, without requiring the user to modify other settings. The user may find out more information about the offer, before making a choice to accept changes, by selecting link 3170. The user may also select additional offers, not viewable on the current page, by selecting link 3191.

Users may authorize the electronic agent 30 to automate the process of building their personal preferences and profile information, example of which are described above. This may make it easier for the participant to have a detailed profile and set of preferences based on using automated information that comes from their existing relationships at various companies. Participants have the ability to change their detailed profile “manually” at any time to better fit their preferences.

Electronic agent 30 may also provide a process for deploying additional information and features via the internet and email including: a) A “potential offers” section that asks participant to verify if they want those companies to send them services or information; b) An “eperformance Counter” (i.e. 3120) that identifies how many companies, emails, phone calls, etc. have been stopped &/or initiated on their behalf; and c) “Recommended offers” (i.e. 3180) that proactively connects potential offers to their preference and profile information.

Electronic Profile Engine may provide an automated process for “tuning-up” the information within the engine by periodically purging old information and gathering new information. Part of the process may include automated trigger points such as life-events (e.g.: having a baby), seasonality, or new activity in a new category (e.g.: just purchased a boat, or just purchased a DVD Player, etc.), as detailed above.

Users may access electronic personal preference network via multiple points such as: a) Existing company relationships where the participant is being asked to agree to a privacy, or users' contract; b) Existing company relationships where the “preferences” service is being as an added benefit to customers; c) New customer relationships as part of the enrollment or registration process, including software registration; d) Internet enrollment; e) Phone enrollment; f) As part of direct mail order forms; etc.

Users may update profile information from thousands of access points across the Internet. Profile information may be captured via access points such as software licensing agreements, financial services agreements and online access agreements. At such contact points, a request may be made to allow the specific company to share information according to appropriate permissions, as described above.

Electronic personal preference network 100 may be engaged by individual participants or businesses via a unique “Speed-start” process, where the participant enrolls with a credit card and/or driver's license number under a secured site and the enrollment engine automatically populates other profile information based upon existing data tied to that credit card. Participant can then tailor profile and preferences when desired.

Electronic personal preference network 100 may provide a unique “contact-speedometer” that allows participant to turn up or down the type and frequency of contact to fit their personal profile. This can be changed by participant, or their actions over time.

Electronic agent 30 may provide an automated process for participating individuals or businesses to make unique simple & streamlined “natural-language” requests for activity to be performed on their behalf. That request is converted automatically to electronic commands that fit the original intent. For example: a) “Stop XYZ magazine” may be automatically be translated into code, connections and commands to electronically drive the originating company of XYZ magazine to stop sending; b) “Find birthday gift ideas for an 8 year old” may be automatically be translated into code, connections and commands to electronically drive companies to provide a response to the specific participant in the way they desire; c) “I just started fly fishing” may be automatically be translated into code, connections and commands to electronically drive an update to their profile and to request relevant companies begin sending you material in the way the participant desires; d) “Recommend a PC” may be automatically be translated into code, connections and commands to electronically pull existing insights on the participant, gather existing product reviews and pricing information, and make suggestions to participants.

A way to simplify the interface and access and/or change of personal profile via an Internet delivered access point that uses natural language requests may also be provided. To minimize the burden and reduce the time required for an end-user to maintain, update, and deepen their personal profile, a simple interface and access will be used to use electronic methods to simplify how much information end users need to interface. One such interface would be a natural language request for a certain activity such as stopping “Coldwater Creek” by typing in that request. Technology will be used to convert simple language into complex database commands.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

Headings are included herein for reference and to aid in locating various sections. These headings are not intended to limit the scope of the concepts described with respect thereto. Such concepts may have applicability throughout the entire specification.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. An apparatus, comprising:
a network; and
an electronic agent for receiving preferences from a user and forming a proxy contract incorporating the preferences, with the user, over the network.

2. A method, comprising:
setting preferences; and
assenting to a proxy relationship between a user and an electronic agent incorporating the set preferences.

3. The method of claim 2, further comprising sending a permission message from the electronic agent to a provider in accordance with the set preferences.

4. An apparatus, comprising:
means for setting preferences; and
means for assenting to a proxy relationship between a user and an electronic agent incorporating the set preferences.

5. Computer readable media operable to perform the following steps:
setting preferences; and
assenting to a proxy relationship between a user and an electronic agent incorporating the set preferences.

6. The apparatus of claim 1, wherein the electronic agent further solicits preferences.

7. The apparatus of claim 1, wherein the electronic agent transmits a permission message in accordance with user preferences.

8. The apparatus of claim 7, wherein the permission message is an authorization.

9. The apparatus of claim 7, wherein the permission message is transmitted in response to a change in user preferences.

10. The apparatus of claim 7, wherein the permission message is transmitted in response to a request from a third party.

11. The apparatus of claim 7, wherein the permission message is transmitted in response to a predefined criteria.

12. The apparatus of claim 11, wherein the predefined criteria comprises determining whether an activity complies with the preferences.

13. The apparatus of claim 12, wherein an activity relates to a channel.

14. The apparatus of claim 12, wherein an activity relates to a provider.

15. The apparatus of claim 12, wherein an activity relates to communication content.

16. The apparatus of claim 12, wherein the predefined criteria comprises a communication request from a third party.

17. The apparatus of claim 7, wherein a permission message relates to a communication.

18. The apparatus of claim 7, wherein a permission message indicates a communication should cease.

19. The apparatus of claim 7, wherein a permission message indicates a communication is allowed.

20. The apparatus of claim 7, wherein a permission message indicates a communication should be modified.

21. The apparatus of claim 7, wherein a permission message indicates user data access is allowed.

22. The apparatus of claim 7, wherein a permission message indicates user data access is disallowed.

23. The apparatus of claim 7, wherein a permission message indicates user data sharing is allowed.

24. The apparatus of claim 7, wherein a permission message indicates user data sharing is disallowed.

25. The apparatus of claim 17, wherein a communication comprises fax.

26. The apparatus of claim 17, wherein a communication comprises email.

27. The apparatus of claim 17, wherein a communication comprises phone.

28. The apparatus of claim 17, wherein a communication comprises direct mail.

29. The apparatus of claim 17, wherein a communication comprises web communication.

30. The apparatus of claim 17, wherein a communication comprises messaging.

31. The apparatus of claim 17, wherein a communication comprises television messaging.

32. The apparatus of claim 17, wherein a communication comprises radio messaging.

33. The apparatus of claim 17, wherein a communication comprises advertising.

34. The apparatus of claim 1, further comprising a server for hosting the electronic agent and communicating with one or more third parties over the network.

35. The apparatus of claim 34, wherein a third party is a user.

36. The apparatus of claim 34, wherein a third party is a provider.

37. A method, comprising:
setting preferences for a user; and
forming a proxy between the user and an electronic agent incorporating the set preferences.

38. The method of claim 37, further comprising:
receiving offers from one or more third parties;
determining if one or more received offers comply with user preferences; and
presenting a potential offer to a user when such a determination is made.

39. The method of claim 37, further comprising sending a permission message from the electronic agent to a provider in accordance with the set preferences.

40. The method of claim 39, wherein the permission message indicates that the provider may start communication to a user on a channel.

41. The method of claim 39, wherein the permission message indicates that the provider may communicate to a user on a channel in accordance with defined parameters.

42. The method of claim 39, wherein the permission message indicates that the provider must stop communication to a user on a channel.

43. The method of claim 39, wherein the permission message indicates that the provider may access user data.

44. The method of claim 37, wherein the proxy is formed by the user assenting electronically to an electronically presented contract.

45. The method of claim 37, further comprising sending a permission from the electronic agent to a provider, the permission formed in response to the set preferences.

46. The method of claim 45, wherein the permission indicates permitted communication from the provider to the user on one or more channels.

47. The method of claim 45, wherein the permission indicates permitted access of user data by the provider.

48. The method of claim 45, wherein the permission indicates permitted sharing of user data by the provider to a third party.

49. The method of claim 37, wherein the set preferences comprise an indicated preference for user information sharing.

50. The method of claim 37, wherein the set preferences comprise one or more indicated preferences for a respective one or more communication channels.

51. The method of claim 50, wherein an indicated preference for a communication channel is set to one of a set of predefined levels.

52. The method of claim 50, wherein the set of predefined levels comprises at least a restrictive level and a relatively less restrictive level.

53. The method of claim 52, wherein the restrictive level indicates a preference for receiving communication from parties with whom the user has a specified relationship.

54. The method of claim 52, wherein the relatively less restrictive level indicates a preference for receiving communication from a group of reputable providers.

55. The method of claim 54, wherein the group of reputable providers comprises providers who have agreed to abide by predetermined standards.

56. An apparatus, comprising:
a user interface for setting preferences for a user, the set preferences comprising an indicated preference for each of a plurality of communication channels; and
a database for storing set user preferences.

57. The apparatus of claim 56, wherein the set preferences further comprise an indicated preference for accessing user data.

58. The apparatus of claim 56, wherein the set preferences further comprise an indicated preference for sharing user data.

59. An apparatus, comprising:
means for setting preferences; and
means for assenting to a proxy relationship between a user and an electronic agent incorporating the set preferences.

60. The apparatus of claim 59, further comprising means for changing preferences.

61. The apparatus of claim 59, further comprising a network interface for setting preferences and assenting over a network.

62. An apparatus, comprising:
means for setting preferences for a user; and
means for forming a proxy between the user and an electronic agent incorporating the set preferences.

63. Computer readable media operable to perform the following steps:
setting preferences for a user; and
forming a proxy between the user and an electronic agent incorporating the set preferences.

64. An apparatus, comprising:
means for receiving a permission, the permission indicating allowed communication to a user on one or more channels; and
means for communicating to the user on one or more channels.

65. An apparatus, comprising:
means for receiving a permission, the permission indicating allowed access to user data; and
means for accessing user data in accordance with the permission.

66. A method, comprising:
identifying an activity;
verifying an activity is in compliance with a permission, the permission generated in accordance with set user preferences; and
recording whether the activity is in compliance.

67. An apparatus, comprising:
means for identifying an activity;
means for verifying an activity is in compliance with a permission, the permission generated in accordance with set user preferences; and
means for recording whether the activity is in compliance.

68. Computer readable media operable to perform the following steps:
identifying an activity;
verifying an activity is in compliance with a permission, the permission generated in accordance with set user preferences; and
recording whether the activity is in compliance.

69. The method of claim 66, further comprising verifying the activity is in compliance with regulations.

70. The method of claim 66, wherein an activity comprises communication to a user on a channel.

71. The method of claim 66, wherein an activity comprises access to user data.

72. The method of claim 66, wherein an activity comprises communication of user data to a third party.

73. A method, comprising:
identifying a violating activity, wherein a violating activity is not in compliance with a permission, the permission generated in accordance with set user preferences; and
performing an enforcement activity when a violating activity is identified.

74. An apparatus, comprising:
means for identifying a violating activity, wherein a violating activity is not in compliance with a permission, the permission generated in accordance with set user preferences; and
means for performing an enforcement activity when a violating activity is identified.

75. Computer readable media operable to perform the following steps:
identifying a violating activity, wherein a violating activity is not in compliance with a permission, the permission generated in accordance with set user preferences; and
performing an enforcement activity when a violating activity is identified.

76. The method of claim 73, wherein a violating activity is further not in compliance with regulations.

77. The method of claim 73, wherein an enforcement activity comprises sending a message on a channel.

78. The method of claim 73, wherein an enforcement activity comprises filing a legal action.

79. The method of claim 73, wherein an enforcement activity comprises filing a complaint with a regulatory agency.

80. A method comprising:
analyzing user data for a user in accordance with a proxy permission; and
updating the user's preference data in response to the user data.

81. The method of claim 80, wherein the user data comprises one or more relationships with a service provider.

82. The method of claim 80, wherein the user data comprises one or more purchases made by the user.

83. The method of claim 80, wherein the user data comprises one or more agreements entered into by the user.

84. The method of claim 80, wherein the user data comprises user activity data.

85. The method of claim 80, wherein the user data comprises data received from a remote database.

86. A method comprising:
setting preferences for a user;
forming proxy permissions for the user; and
updating a list in response to the user's preferences and proxy permissions.

87. The method of claim 86, wherein the list comprises disallowed communications.

88. The method of claim 86, wherein the list comprises allowed communications.

89. The method of claim 86, wherein the list is a black list.

90. The method of claim 86, wherein the list is a white list.

91. The method of claim 86, wherein the list is used for email.

92. The method of claim 86, wherein the list is used for telephone.

93. The method of claim 86, wherein the list is used for web access.

94. The method of claim 86, wherein the list is used for personal digital video recorder permission.
